(19) United States
(12) Patent Application Publication
(10) Pub. No.: US 2018/0315271 A1
(43) Pub. Date: Nov. 1, 2018

(54) Intelligent or Automated Vending Machine

(71) Applicant: Shadecraft, Inc., Pasadena, CA (US)

(72) Inventor: Armen Sevada Gharabegian, Glendale, CA (US)

(73) Assignee: Shadecraft, Inc.

(21) Appl. No.: 15/831,298

(22) Filed: Dec. 4, 2017

Related U.S. Application Data
(60) Provisional application No. 62/492,541, filed on May 1, 2017.

(51) Int. Cl. G07F 11/72; F03G 6/00; F03D 9/00; G10L 15/26; G06F 3/048; H04W 4/90

(52) U.S. Cl. CPC G07F 11/72; F03G 6/001; H04W 4/90; G10L 15/265; G06F 3/048; F03D 9/007

(57) ABSTRACT

An automated vending machine, includes one or more solar panels, the one or more solar panels converting solar energy or light energy into electrical energy, and a vending machine body, the one or more solar panels attached to a top surface of the vending machine body. The vending machine body includes a product display area, a product dispensing assembly to obtain a selected product from the product display area and deliver the selected product to an opening in a front surface of the vending machine body, and a liquid dispensing assembly to dispense liquid to a container positioned near the vending machine body. The vending machine body includes a microphone to receive voice commands and to convert voice commands into audio signals; and an audio transceiver and sound reproduction device.

### RELATED APPLICATIONS

This application claims priority to application Ser. No. 62/492,541, filed on May 1, 2017, and entitled “Intelligent Vending Machine,” the disclosure of which is incorporated by reference.

### BACKGROUND

### 1. Field

This patent application relates to an automated vending machine and more specifically an automated vending machine operable in remote areas where AC power is not readily available.

### 2. Background of the Invention

Vending machines are mainly placed in urban or suburban areas where large amount of people are present and the vending machines are accessible for restocking by manufacturers or distributors. Consumers purchase products on a regular basis from these vending machines and due to accessibility, they can be easily restocked. In addition, vending machines normally require a large amount of AC power or line power in order to refrigerate the stocked goods and provide lighting to allow for purchase of goods in low light environments.

However, vending machines are not normally present in remote areas because foot traffic and the amount of goods that are purchased is low. Thus, the cost of operation may be prohibited. In addition, the lack of available line power makes it difficult for a vending machine to operate in remote locations.

### BRIEF DESCRIPTION OF THE DRAWINGS

FIG. 1A illustrates a front view of an intelligent vending machine according to embodiments;

FIG. 1B illustrates operation of temperature sensors and/or humidity sensors in a vending machine according to embodiments;

FIG. 1C illustrates a vending machine having an upper support assembly and a lower support assembly connected by a hinging assembly to couple solar panel assemblies to the vending machine according to embodiments;

FIG. 1D illustrates a liquid dispensing assembly according to embodiments;

FIG. 2 illustrates a block diagram of components of an intelligent vending machine according to embodiments;

FIG. 3 illustrates an unmanned aerial vehicle (UAV) according to embodiments;

FIG. 4 illustrates a side view of an intelligent vending machine;

FIG. 5 illustrates an intelligent vending machine with one or more solar and/or shading assemblies according to embodiments;

FIG. 6A illustrates a top view of a possible configuration of one or more solar and shading assemblies with respect to a vending machine according to embodiments;

FIG. 6B illustrates a top view of another possible configuration of one or more solar and shading assemblies according to embodiments;

FIG. 7A illustrates an intelligent vending machine with a movable base assembly according to embodiments;

FIG. 7B illustrates a method of a movable base assembly moving an intelligent vending machine according to embodiments;

FIG. 7C illustrates another method of a movable base assembly moving an intelligent vending machine according to embodiments; and

FIG. 7D illustrates another method of a movable base assembly moving an intelligent vending machine according to embodiments.

### DETAILED DESCRIPTION

Embodiments are described in detail below with respect to the drawings. Like reference numbers are used to denote like parts throughout for consistency.

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail. Vending machine may be referred to as “intelligent” and/or “automated” (which may be used interchangeably). “Intelligent” and/or “automated” means vending machine has functionality that may be performed in response to voice commands, based on certain events occurring and/or in response to commands, instructions, signals and/or messages received from other computing devices (e.g., mobile computing devices, servers, remote computing devices, etc.).

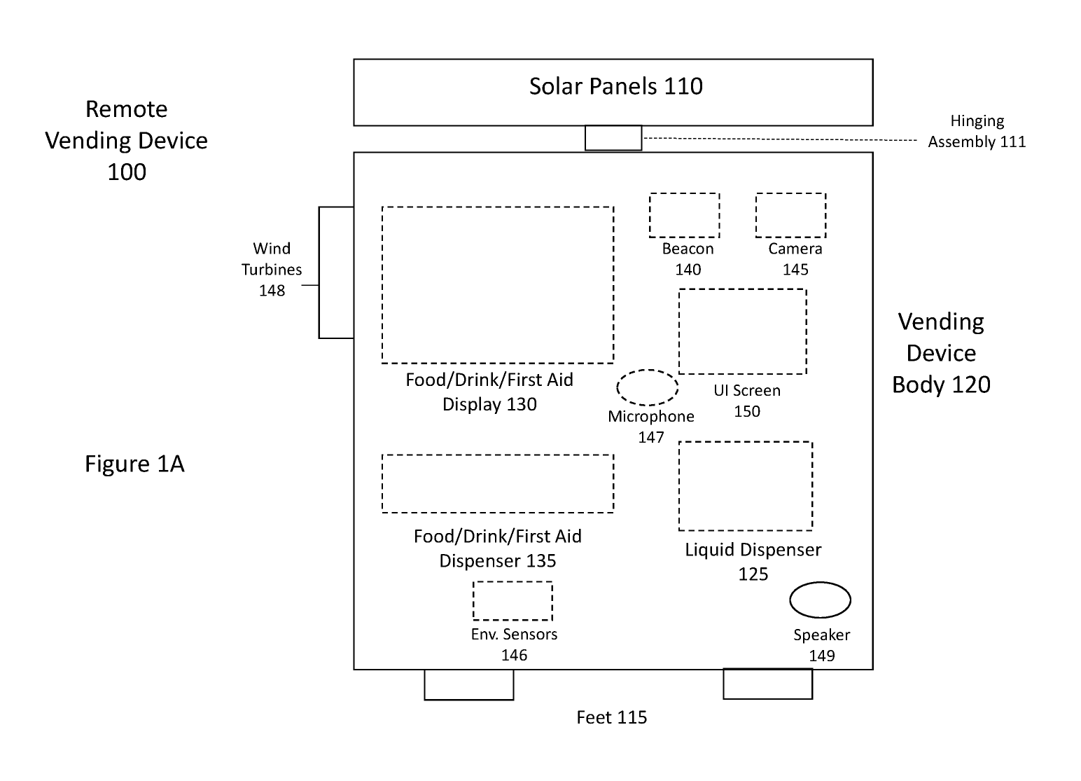

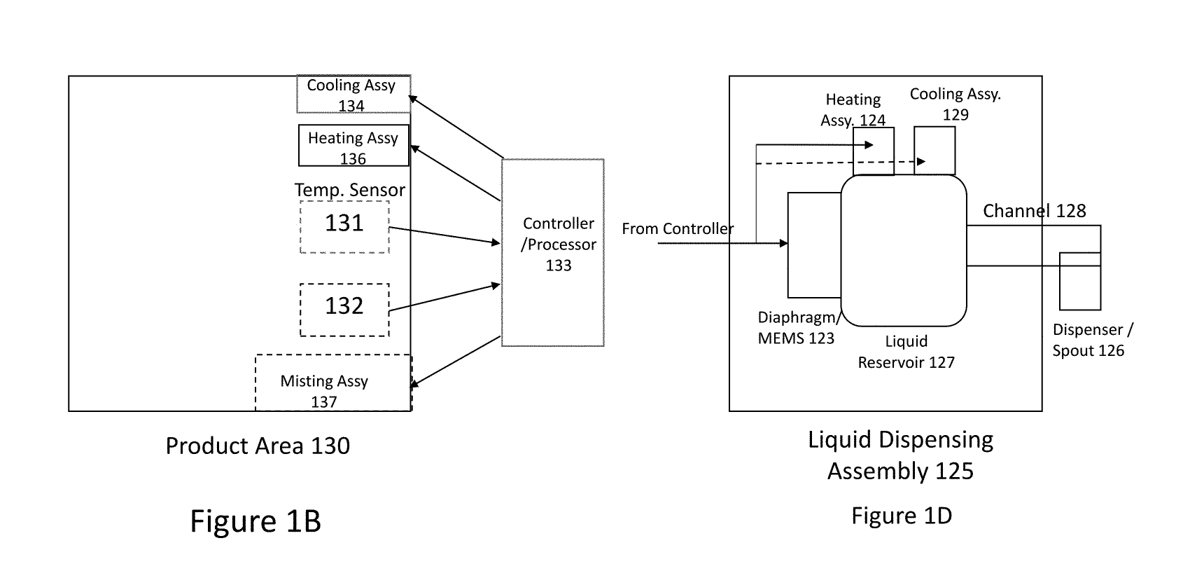

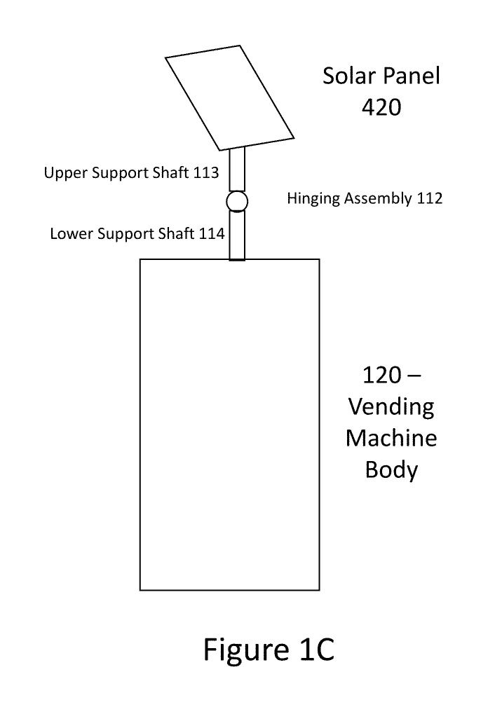

FIG. 1A illustrates a front view of an intelligent or automated vending machine according to embodiments. In embodiments, a vending machine 100 may comprise one or more solar panels 110 and a vending machine body 120. In embodiments, a vending machine 100 may comprise one or more feet 121 and/or support assemblies 115 to allow a vending machine to rest off of a ground surface and/or to provide clearance off a ground surface for a vending machine 100.

In embodiments, an automated vending machine body 110 may comprise a product display area 130. In embodiments, a product display area 130 may have a transparent front surface and a product holding area. In embodiments, products may be hung on racks and/or shelves in a product holding area and may be viewable through a transparent surface. In embodiments, a transparent surface may be glass, plastic and/or plexiglass. In embodiments, a front surface may be a surface which is transparent but changes to a more opaque or reflective surface if too much sunlight is present. In embodiments, this prevents a temperature in a product holding area from rising and causing quality issues with products stored therein. In embodiments, a product storage area may also comprise one or more lighting assemblies to shine light onto products stored therein during low light and/or no light conditions. In embodiments, one or more lighting assemblies may comprise one or more LED assemblies.

In embodiments, a product display area 130 may be coupled, connected to and/or attached a product dispensing assembly 135. In embodiments, a product dispensing assembly 135 may comprise a product dispensing area and a mechanical picking assembly. In embodiments, a product dispensing area may be a drop area below a product display area 130. In embodiments, a mechanical picking assembly receives commands via a user interface 150, selects a product from a product display area (e.g., off a rack or display), and drops a selected product into a drop area. In embodiments, a product dispending assembly 135 may be located and/or positioned to a side of a product display area. In embodiments, a mechanical picking assembly may be a robotic and/or computer controlled assembly that selects a product from a rack and/or hanger based upon input received, via one or more processors and/or via the user interface 150, moves a selected product in a horizontal or close to horizontal direction to a dispensing assembly and places the selected product into a dispensing assembly. In embodiments, a dispensing assembly may provide a product for a user to retrieve. In embodiments, a dispending assembly may be a plastic holder, for example, that may be mechanically moved via and pop out to allow a user to access a selected product. This is different from being dropped in to a dispensing area and may be important for products that are too fragile to be dropped and/or shaken.

In embodiments, products for sale in the intelligent vending machine 100 may be food, snacks, drinks, first aid supplies, electronic devices and/or computing supplies. In embodiments, the products may be present in a product holding area 130. In embodiments, a product holding area 130 may be coupled to a cooling system (e.g., an air conditioner, a condenser and/or fan system) if products provided in the vending machine require a cool atmosphere. In embodiments, a product holding area 130 may comprise a temperature sensor 131 and/or a humidity sensor 132 to measure environmental conditions within a product holding area 130. FIG. 1B illustrates operation of temperature sensors and/or humidity sensors according to embodiments. In embodiments, a temperature sensor 131 may capture a temperature measurement in a product holding area 130 and may communicate a temperature measurement or temperature value to a processor or controller 133. In embodiments, computer-readable instructions stored in one or more memory devices executable by the processor or controller 133 may receive the temperature value and determine if a product area 130 needs to have a temperature adjusted. If the temperature needs to be adjusted, computer-readable instructions executable by one or more processors or controllers 133 may cause the processor or controller 133 to generate an activation signal to a cooling apparatus 134 (e.g., a fan, a condenser or an air conditioner) if a temperature in a product area needs to be lowered. In embodiments, a cooling apparatus 134 is activated which results in air movement or cool air being introduced into the product area. In embodiments, if a temperature measurement is too low, computer-readable instructions executable by the processor or controller 133 may communicate a signal, command, message and/or instruction to a heating assembly 136 (e.g., a heating coil, a heating fan, etc.) to activate and blow heated air into a product holding area. This is an advantage over other vending machines because when out-of-tolerance conditions are measured within a product holding area, products may become damaged and/or spoiled and thus ruined. In embodiments, a humidity sensor 132 may capture a humidity measurement in a product area and may communicate the captured humidity measurement to a processor and/or controller 133. In embodiments, computer-readable instructions stored in one or more memory devices and executable by one or more processors and/or controllers 133 may generate an activation signal, command, instruction and/or message and communicate the signal to a misting system 137 to activate and dispense a mist into a product holding area 130. In embodiments, the misting system 137 may cause a humidity level to return to an acceptable level. In embodiments, first aid products and/or assistance products may comprise sunscreen, blankets and/or hats to protect a user from environmental conditions that may endanger health.

In embodiments, one or more solar panels and/or solar panel assemblies 110 may capture light and/or sunlight and convert light and/or sunlight into electric power. In embodiments, electric power generated by one or more solar panel assemblies 110 may charge and/or be stored in a rechargeable battery. In embodiments, during daylight hours, one or more solar panel assemblies 110 may generate enough power to power a vending machine 100 during daylight hours and may also charge a rechargeable battery to provide additional powers during evening hours.

In embodiments, one or more shafts and/or hinging assemblies 111 may connect one or more solar panel assemblies 110 to a vending machine body 120. In embodiments, one or more shafts 111 may rotate with respect to a vending machine body 120. In embodiments, one or more shafts 111 may rotate around a vertical or azimuth axis. In embodiments, one or more shafts 111 may rotate approximately 360 degrees about a vertical axis or azimuth to allow one or more solar panel assemblies to follow a light source (e.g., such as a sun).

In embodiments, a first motor assembly comprises a first motor shaft that may rotate in response to activation and/or utilization of a first motor. In embodiments, a first motor shaft may be mechanically coupled (e.g., a gearing system, a friction-based system, etc.) to a force transfer shaft. In embodiments, a first motor shaft may rotate in a clockwise and/or counterclockwise direction and in response, a force transfer shaft may rotate in a same and/or opposite direction. In embodiments, a force transfer shaft may pass may be mechanically coupled to a receptacle in a vending machine body 120. In response to, or due to, rotation of force transfer shaft in a receptacle in a vending machine body, a support shaft or support assembly 111 (and thus solar panels or solar cells 110) may rotate with respect to a vending machine body 120. In embodiments, a first motor may be coupled to a gearbox assembly. In embodiments, a gearbox assembly may comprise a planetary gearbox assembly. A planetary gearbox assembly may be comprise a central sun gear, a planet carrier with one or more planet gears and an annulus (or outer ring). In embodiments, planet gears may mesh with a sun gear while outer rings teeth may mesh with planet gears. In embodiments, a planetary gearbox assembly may comprise a sun gear as an input, an annulus as an output and a planet carrier (one or more planet gears) remaining stationary. In embodiments, an input shaft may rotate a sun gear, planet gears may rotate on their own axes, and may simultaneously apply a torque to a rotating planet carrier that applies torque to an output shaft (which in this case is the annulus). In embodiments, a planetary gearbox assembly and a first motor may be connected and/or adhered to a support shaft or support assembly 111 although it may be resident within the vending machine body 120. In embodiments, a motor and gearbox assembly may be resident within a vending machine body 120. In embodiments, an output shaft from a gearbox assembly may be connected to a vending machine body 120 (e.g., an opening of a vending machine body) and/or a support shaft or support assembly 111. In embodiments, because a vending machine body 120 may be stationary, torque on an output shaft of a gearbox assembly may be initiated by a first motor to cause a support shaft or support assembly 111 (and thus solar cells or solar panels 110) to rotate. In embodiments, other gearbox assemblies and/or hinging assemblies may also be utilized to utilize an output of a motor to cause a support shaft or support assembly 111 (and hence solar cells or solar panels 110) to rotate with respect to a vending machine body 120. In embodiments, a first motor may comprise a pneumatic motor, a brushless DC motor, a servo motor and/or a stepper motor.

In embodiments, one or more shafts 111 may comprise one or more hinging assemblies 112. FIG. 1C illustrates a vending machine having an upper support assembly and a lower support assembly connected by a hinging assembly to couple solar panel assemblies to the vending machine according to embodiments. In embodiments, one or more hinging assemblies 112 may provide an additional axis rotation for one or more solar panel assemblies 110 with respect to a vending machine body 120. In embodiments, one or more hinging assemblies 112 may allow an upper portion 113 of one or more shafts 111 to rotate with respect to a lower portion 114 of one or more shafts 111. In embodiments, this may cause one or more solar panel assemblies 110 to rotate about a rotational axis (as illustrated by reference number 117) with respect to a vending machine body 120. This may be referred to as an elevation adjustment or rotation. In embodiments, this may provide an advantage of having solar panel assemblies 110 rotate and/or move with respect to movement of a sun in a horizon (based on angle of a sun on a horizon).

In embodiments, an upper portion of one or more shafts or an upper support assembly 113 may be coupled and/or connected to a lower section of a lower support assembly 114 via a hinging assembly 112. In embodiments, a support shaft or support assembly 110 may comprise an upper support assembly 113, a second gearbox assembly (or a linear actuator or hinging assembly) 112, a lower support assembly 114, a second motor, and/or a second motor controller. In embodiments, a second motor assembly may comprise a second motor controller and a second motor, and maybe a second gearbox assembly or linear actuator. In embodiments, a support shaft or support assembly 110 may also comprise a motor control which may have a second motor controller mounted and/or installed thereon. In embodiments, an upper support assembly 113 may be coupled or connected to a lower support assembly 114 via a hinging assembly 112 (e.g., a second gearbox assembly). In embodiments, a second gearbox assembly and a second motor connected thereto, may be connected to an upper support assembly 113. In embodiments, an output shaft of a second gearbox assembly may be connected to a lower support assembly 114. In embodiments, as a second motor operates and/or rotates, a second gearbox assembly rotates an output shaft which causes an upper support assembly 113 to rotate (either upwards or downwards) at a right angle from, or with respect to, a lower support assembly 114. In embodiments utilizing a linear actuator as a hinging assembly 112, a steel rod may be coupled to an upper support assembly 113 and/or a lower support assembly 114 which causes a free hinging between an upper support assembly 113 and a lower support assembly 114. In embodiments, a linear actuator may be coupled, connected, and/or attached to a second support assembly 113 and/or a first support assembly 114. In embodiments, as a second motor operates and/or rotates a steel rod, an upper support assembly 113 moves in an upward or downward direction with respect to a hinged connection (or hinging assembly) 112.

In embodiments, a lower support assembly 114 may comprise an elevation motor, an elevation motor shaft, a worm gear, and/or a speed reducing gear. In embodiments, a speed reducing gear may be connected with a connector to a connection plate. In embodiments, a lower support assembly 114 may be mechanically coupled to an upper support assembly 113 via a connection plate. In embodiments, a connection plate may be connected to an upper support assembly 113 via a connector and/or fastener. In embodiments, an elevation motor may cause rotation (e.g., clockwise or counterclockwise) of an elevation motor shaft, which may be mechanically coupled to a worm gear. In embodiments, rotation of an elevation motor shaft may cause rotation (e.g., clockwise or counterclockwise) of a worm gear. In embodiments, a worm gear may be mechanically coupled to a speed reducing gear. In embodiments, rotation of a worm gear may cause rotation of a speed reducing gear via engagement of channels of a worm gear with teeth of a speed reducing gear. In embodiments, a speed reducing gear may be mechanically coupled to a connection plate to a second support assembly via a fastener or connector. In embodiments, rotation of a speed reducing gear may cause a connection plate (and/or an upper support assembly 113) to rotate with respect to a lower support assembly 113 in a clockwise or counterclockwise direction. In embodiments, an upper support assembly 113 may rotate with respect to a lower support assembly 114 approximately 90 degrees via movement of the connection plate. In embodiments, an upper support assembly 113 may rotate approximately 0 to 30 degrees with respect to lower support assembly 114 via movement of the connection plate. In embodiments, rotation of support shafts with respect to an automated intelligent vending machine body may occur to track the sun and obtain better position for the solar cells or solar panel assemblies 110 to obtain light from the sun. In addition, rotation of support shafts or support assemblies with respect to each other via a hinging assembly may occur to track the sun and obtain better position for the solar cells or solar panel assemblies 110 to obtain light from the sun. In embodiments, computer-readable instructions executable by one or more processors in an automated vending machine may instruct one or more processors to generate and communicate instructions, commands, messages or signals to the motors or motor controllers (and other assemblies or components) that control movement of support shafts, support assemblies and/or hinging assemblies.

In embodiments, one or more wind turbines and/or wind power assemblies 148 may be coupled, attached and/or connected to a vending machine body 120. In embodiments, one or more wind turbines 148 may generate power for a vending machine 100 during evening hours, e.g., when one or more solar panels 110 may not be generating power. In embodiments, especially during high wind conditions, one or more wind turbines 148 may generate power in additional to solar power assemblies 110. In embodiments, one or more wind turbines 148 may generate power which may be stored in a rechargeable battery.

In embodiments, solar panel assemblies 110 may provide a vending machine 100 with power in remote environments without having to run power lines to an area where the vending machine is installed. In embodiments, wind turbines 148 may also provide a vending machine 100 with power in remote environments. In embodiments, one or more solar panel assemblies 110 may generate power during a day when sunlight is present and one or more wind turbines 148 may provide power during a nighttime when higher winds are present.

In embodiments, a vending machine 100 may comprise a liquid dispensing assembly 125. In embodiments, a liquid dispensing assembly 125 may be located within a vending machine body 120. In embodiments, a liquid dispensing assembly 125 may dispense water, purified water, soda water, juices, soda, and carbonated beverages. In embodiments, a liquid dispensing assembly 125 may dispense hot beverages and/or cold beverages. In embodiments, for example, when a vending machine 100 is located in a remote area such as a desert, a vending machine 100 may dispense cold beverages to provide liquid to individuals who may lack water and/or need assistance. FIG. 1D illustrates a liquid dispensing assembly according to embodiments. In embodiments, a liquid dispensing assembly 125 may comprise a liquid dispenser, spout, or nozzle 126, a liquid reservoir 127 of holding and/or storing a liquid, a channel 128 for transporting and/or moving a liquid from a liquid reservoir 127 to a liquid dispenser or spout 126. In embodiments, a liquid dispensing assembly 125 may comprise a cooling assembly 129 (e.g., condenser, fan, etc.) to keep a liquid at an enjoyable or healthy temperature when a liquid is in a liquid reservoir 127. Similarly, in embodiments, a heating assembly 124 (e.g., heating coil or heating element) may provide heat to keep a liquid in a liquid reservoir 127 at a desired and/or preset temperature. In embodiments, a liquid dispenser 126 may dispense liquid into a provided cup and/or container. In embodiments, a liquid reservoir 127 may be a diaphragm or a MEMS sensor 123 may press against a diaphragm to cause a liquid to be dispensed from the liquid reservoir 127 into a channel 128 and then to the liquid dispenser or spout 126. In embodiments, computer-readable instructions executable by a controller or processor in a vending machine 100 may communicate a command, instruction, message and/or signal to a MEMS sensor or diaphragm 123 to activate dispensing of a liquid. In embodiments, computer-readable instructions executable by a controller or processor in a vending machine 100 may communicate a command, instruction, message and/or signal to a heating assembly 124 (to activate the heating assembly 124 and warm a liquid in a reservoir 127) or to communicate a command, instruction, message and/or signal to a cooling assembly 129 (to activate the cooling assembly 129 and cool a liquid in a reservoir 127). In embodiments, a liquid dispenser 125 may comprise an area where an individual may place a cup and/or container in order to capture a liquid. In embodiments, for example, where individuals may not be carrying containers, e.g., remote areas such as a desert, a liquid dispenser 126 may comprise a hose or similar assembly to allow an individual to receive liquid from the liquid dispenser and not have to press up against a vending machine in order to drink a dispensed liquid.

In embodiments, automated vending machines 100 may be located in a desert and/or any other challenging or harsh environment (an area that experiences monsoons, high winds, sand storms, etc. In embodiments, a vending machine 100 may include an emergency beacon generator 140 to generate a beacon signal to identify that a person and/or individual is in distress at a location of vending machine 100. In embodiments, a vending machine body 120 may comprise an emergency beacon and/or signal generator 140. In embodiments, an emergency beacon and/or signal generator 140 may generate a light or a beacon that is displayed in a sky and/or atmosphere. In embodiments, an emergency beacon and/or signal generator 140 may generate a sonic signal at a specified frequency and/or repetitive pattern to indicate that a party is in distress at a location of the vending machine. In embodiments, a sonic signal or wireless signal may further comprise an element that identifies a vending machine (with a known location) or includes GPS coordinates. In embodiments, an emergency beacon and/or signal generator 140 may generate an emergency broadcast signal that may be received by local radios, televisions and/or computing devices, so that individuals may be rescued.

In embodiments, a vending machine 100 may have one or more cameras 145. In embodiments, a vending machine body 120 may have one or more cameras 145. In embodiments, cameras 145 may capture images, video and/or sound in areas surrounding a vending machine 100. In embodiments, images, video and/or sound captured may be utilized by a vending machine 100 for facial recognition, health assessments, and/or image, video and/or sound transmission.

In embodiments, an automated vending machine 100 may receive input from users and/or operators in a number of manners. In embodiments, a vending machine body 120 may have one or more input screens and/or graphical user interfaces (GUI) 150. In embodiments, a user interface screen 150 may be a touchscreen accepting input from a hand, a stylus hand, and/or may display buttons that a user may select. In embodiments, a user interface screen 150 may also display input screens and/or message screens to users and/or operators. In embodiments, a portable computing device may communicate with a vending machine body 120 to provide instructions. In embodiments, a vending machine body 120 may comprise one or more microphones 147. In embodiments, one or more microphones 147 may receive audio input from users and/or operators and convert received audio input to audio signals. In embodiments, computer-readable instructions executable by one or more processors may convert audio signals to audio files. In embodiments, a vending machine 100 may perform and/or execute actions based on receive audio input.

In embodiments, a vending machine 100 may comprise one or more speakers 149. In embodiments, a vending machine body 120 may comprise one or more speakers 149. In embodiments, one or more speakers 149 may output audible sound instructing an operator and/or users to perform actions. In embodiments, one or more speakers 149 may provide warnings to users and/or operators about operational conditions of a vending machine 100 or an environment surrounding a vending machine.

In embodiments, an automated vending machine 100 may comprise environmental sensors 146 to measure environmental conditions surrounding and/or adjacent to a vending machines 100. In embodiments, a vending machine body 120 may comprise one or more environmental sensors 146. In embodiments, one or more environmental sensors 146 may comprise one or more temperature sensors, humidity sensors, air quality sensors, a carbon monoxide sensors, wind sensors and/or ultraviolet sensors. In embodiments, one or more environmental sensors 146 may generate measurements, readings and/or values based at least in part on environmental conditions in an area surrounding a vending machine. In embodiments, one or more environmental sensors 146 may communicate and/or transmit measurements, readings and/or values to one or more processors in a vending machine body 120.

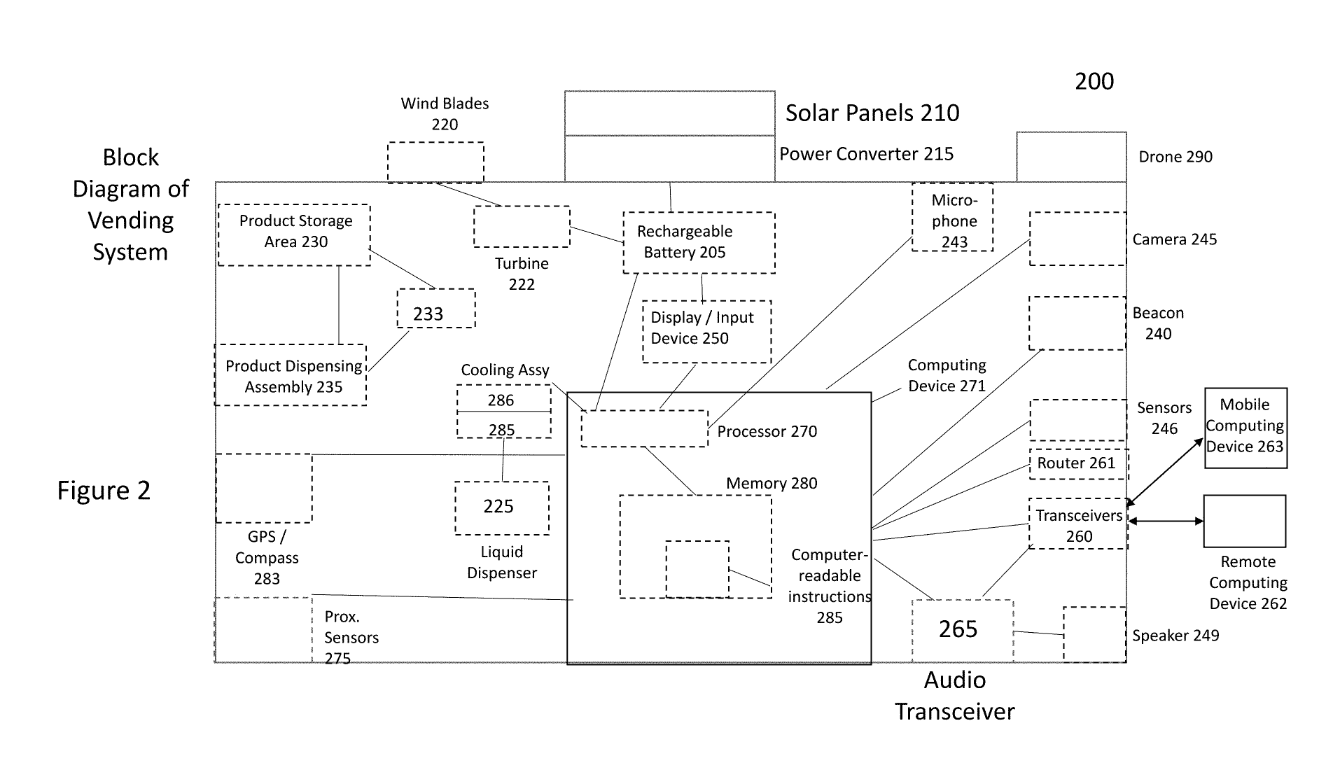

FIG. 2 illustrates a block diagram of components of an intelligent or automated vending machine according to embodiments. In embodiments, an automated vending machine 200 may be powered via one or more solar panels 210 plus power converter 215 and/or one or more propeller blades 220 plus one or more wind turbines 222. In embodiments, one or more solar panels 210 may capture sunlight and convert sunlight into electrical power and/or energy via a power converter 215. In embodiments, a power converter 215 may transfer energy to one or more rechargeable batteries 205 in a vending machine. In embodiments, one or more rechargeable batteries 205 may provide power (e.g., voltage and/or current) to various assemblies, devices and/or components in a vending machine 100, as is illustrated in FIG. 2. In embodiments, one or more wind blades 220 may be placed in a sock and/or area where wind may be able to capture or be moved by wind in the environment. In embodiments, one or more wind blades 220 may drive and/or spin shafts, where the spinning shafts may be connected to a turbine 222. In embodiments, one or more wind turbines 222 may generate electricity based on the spinning of the shafts or driving of one or more shafts. In embodiments, one or more turbines 222 generate electricity (voltage and/or current) to charge a rechargeable power source 205 (e.g., a rechargeable battery). In embodiments, a rechargeable battery 205 may provide power to assemblies, components and/or devices (e.g., a computing device 265).

In embodiments, a vending machine 100 may communicate with external computing devices via transceivers 260 (either WiFi or any 802.11 wireless communication transceiver, cellular transceivers and/or PAN transceivers). In embodiments where a vending machine is remote (in a desert and/or less crowded area), it may be preferable to communicate through direct cellular communications (e.g., a cellular (3G, 4G or 5G) transceiver) rather than other wireless communications, which may not be available. In embodiments, a wireless transceiver 260 may need to act as a hotspot in order to connect to a global communications network. In embodiments, a vending machine 100 may further comprise a router 261 in order to connect to a global communications network in a remote area where very little wireless connectivity is available. Other example communication transceivers include NFC transceivers, WPAN radios or transceivers compliant with various IEEE 802.15 (Bluetooth™) standards, WLAN radios or transceivers compliant with any of the various IEEE 802.11 (WiFi™) standards, WWAN (3GPP, 4G or 5G-compliant) radios or transceivers for cellular telephony, wireless metropolitan area network (WMAN) radios or transceivers compliant with various IEEE 802.16 (WiMAX™) standards, and wired local area network (LAN) Ethernet transceivers.

In embodiments, a vending machine 100 may comprise a computing device 271 or one or more computing devices 271. In embodiments, a computing device 271 may be a single-board computer such as Raspberry Pi, Arduino board, a DJI A2 or other similar controllers or processors. In embodiments, a computing device 271 may comprise one or more processors 270 and one or more memory devices or modules 280. In embodiments, computer-readable instructions, computer-executable instructions or software 285 may be stored in one or more memory devices or modules 280, may be accessed and executed by the one or more processors 270 to perform functions of the vending machine and communicate with other components or assemblies of the vending machine. In embodiments, one or more processors 270, one or more memory devices 280 and/or computer-readable instructions 285 may not be inside an integrated computing device 271.

In embodiments, a vending machine 100 may have voice recognition capabilities and/or functionality, which may be implemented via computer-readable instructions 285 executable by one or more processors 270 which perform voice recognition locally within the vending machine 100. This may be important in situations where there is little or no wireless or wired connection capability due to remoteness of vending machine. In embodiments, a module or portion of computer-readable instructions or software 285 may be a voice recognition engine or software. In embodiments, one or microphones 243 may capture spoken audio commands and may convert spoken audio commands into audio signals. In embodiments, computer-readable instructions 285 executable by one or more processors 270 may convert received audio signals into audio files. In embodiments, a portion or section of computer-readable instructions 285 (e.g., the voice recognition engine) executable by the one or more processors 270 may analyze the received audio files and identify commands representative or indicative of the audio in the received audio files. In embodiments, computer-readable instructions 285 executable by one or more processors 270 may receive the recognized or identified commands and the one or more processors 270 may generate and communicate commands, instructions, messages and/or signals to other components (e.g., sensors, transceivers) or assemblies (e.g., solar panel assemblies, liquid dispensing assembly, heating assembly) of the vending machine to perform actions based at least in part on the received audio commands. In other words, voice commands may command operations of the vending machine 100. In another embodiment, if wireless communications is available to the vending machine 100, a voice recognition engine or voice-recognition capability may be present on an external computing device or server 272. In this embodiment, a portion of computer-readable instructions 285 stored in one or more memory devices 280 may be a voice-recognition application programming interface (API). In embodiments utilizing a voice-recognition API, voice-recognition API computer-readable instructions executable by one or more processors 260 may communicate the converted audio files to a remote computing device or server 262 via one or more wireless communication transceivers 260 and/or a router 261. In embodiments, voice-recognition computer-readable instructions executable by one or more processors on a remote computing device or server 262 may analyze the received audio files and generate commands, instructions, and/or messages representative or indicative of the original voice commands spoken by a user or operator and communicate the generated commands, instructions and/or messages to the vending machine 100, where it is received via one or more wireless transceivers 260 and communicated to the one or more processors or controllers 270. In embodiments, computer-readable instructions 285 executable by the one or more processors or controllers 270 may 1) receive the generated commands, instructions and/or messages; 2) generate component or assembly commands, instructions and/or messages; and 3) communicate the generated component or assembly commands, instructions and/or messages to associated components and/or assemblies in the vending machine 100 to have the components or assemblies perform the requested actions.

In embodiments, a vending machine 100 may have face recognition capabilities either implemented via local computer-readable and executable instructions or via a face recognition and/or artificial intelligence API. This may be important in situations where there is little or no wireless or wired connection capability due to remoteness of vending machine. In embodiments, a module or portion of computer-readable instructions or software 285 may be a facial recognition engine or facial recognition software. In embodiments, in response to computer-readable instructions executable by one or more processors, one or cameras 243 may capture video and/or images and may communicate the captured video and/or images to one or more processors 270 and/or one or memory devices 280. In embodiments, a portion or section of computer-readable instructions 285 (e.g., the facial recognition engine or facial recognition software) executable by the one or more processors 270 may analyze the captured images and extract a facial image from the captured images. In embodiments, a vending machine 100 may have previously stored images of individuals who are visiting or resident within an area where the vending machine 100 is located. For example, a vending machine 100 may be installed in a national park and all visitors to a national park may have their picture taken (e.g., an image captured) and these visitor images may be communicated to vending machines in the national park and stored within one or more memory devices 280 of a vending machine. Similarly, a vending machine in or near a remote village may have images of residents stored within one or more memory devices 280 of a vending machine 100/200. In embodiments, computer-readable instructions 285 executable by one or more processors 270 may compare the extracted facial image with stored facial images to determine if a match is made and an individual is recognized and/or identified. In embodiments, if an individual is identified or recognized, computer-readable instructions 285 executable by one or more processors 270 may communicate messages, instructions and/or images of the recognized or identified individual to remote computing devices or servers 262 to let third-parties (e.g., medical personnel, location personnel or first responder personnel) know which individuals are utilizing the vending machine. In another embodiment, if wireless communications is available to the vending machine 100, a face recognition engine or face recognition software may be present on an external computing device or server 262. In this embodiment, a portion of computer-readable instructions 285 stored in one or more memory devices 280 may be a facial-recognition application programming interface (API). In embodiments utilizing a facial-recognition API, facial recognition API computer-readable instructions executable by one or more processors 260 may communicate the captured images or video to a remote computing device or server 262 via one or more wireless communication transceivers 260 and/or a router 261. In embodiments, facial recognition computer-readable instructions executable by one or more processors on a remote computing device or server 262 may analyze the received images and generate commands, instructions, and/or messages identifying the individual and communicate the generated commands, instructions and/or messages to the vending machine 100, where it is received via one or more wireless transceivers 260 and communicated to the one or more processors or controllers 270. In embodiments, computer-readable instructions 285 executable by the one or more processors or controllers 270 may 1) receive the generated commands, instructions and/or messages; 2) generate commands, instructions and/or messages; and 3) communicate the generated commands, instructions and/or messages and/or the captured image to remote computing devices 262 as discussed above with respect to embodiments where facial recognition is performed or executed on the vending machine 100.

In embodiments, a vending machine 100 may comprise one or more GPS receivers and/or digital compasses 283. In embodiments, one or more GPS receivers and/or digital compasses 283 may be utilized separately and/or in combination to determine a location and/or positioning from a reference location. In embodiments, for example, one or more GPS receivers 283 may measure and/or generate a latitude, a longitude, and/or an altitude for a vending machine 100. In embodiments, computer-readable instructions 285, stored in one or more memory devices 280, may be executed by one or more processors to receive communicated GPS measurements or measurement values and may communicate the measured latitude, longitude and/or altitude, via one or more wireless transceivers 260 to a remote computing device to identify a specific location of an individual and/or a vending machine. In embodiments, computer-readable instructions 285 executable by one or more processors 270 may instruct a GPS transceiver 283 to communicate directly through a GPS satellite network to identify a location of an individual using a vending machine that may be in distress. In embodiments, utilization of GPS coordinates may provide an advantage over prior art vending machines because a machine (or computing device) may provide an accurate location for an individual in trouble without relying on communication from an individual who may be physically or mentally unable (due to the extreme weather or environmental conditions) to provide such accurate location information. In embodiments, one or more digital compasses 283 may generate and/or calculate measurements or values identifying a location of a vending machine with respect to a reference heading (e.g., from true north and/or magnetic north). In embodiments, computer-readable instructions 285 executed by one or more processors 270 may receive digital compass 283 measurements and/or headings and may communicate the digital compass headings or measurements, via one or more wireless transceivers 260, to a remote computing device to provide location information and/or measurements for an individual, in addition to or alternatively to GPS transceiver measurements.

In embodiments, a vending machine 100 may comprise one or more beacon generators 240. In embodiments, an emergency beacon and/or signal generator 240 may provide an additional avenue for an individual to identify they are in distress or that an emergency situation is present. For example, an individual may not know whether a remote computing system is being monitored and thus location measurements and/or other distress communications are being received. For example, if a vending machine 100 utilizes cellular transceivers 260 to attempt to contact individuals, there is no guarantee the individual will receive the call or even has a wireless communication device activated and/or turned on. As an additional example, in a national park, the remote computing device may be located in a ranger station, but the computing device may be unmonitored during certain periods of the day and/or night. In such embodiments, an emergency beacon and/or signal generator 240 may generate an projection onto a sky which may be seen and/or recognized as identifying an emergency situation (and potentially which vending machine generated the projection). By knowing the vending machine that generated the emergency beacon, rescuers or emergency personnel may know a specific or general area where an individual in distress may be located. In embodiments, an emergency beacon generator may generate a radiofrequency signal (in a known emergency signal format and with location identifying information) which remote radio frequency receivers may recognize as identifying emergency conditions. In embodiments, an emergency beacon and/or emergency signal may also include preprogrammed location information. In embodiments, an emergency beacon and/or signal generator 240 may be a backup or redundant system for other notification systems (e.g., GPS receivers, digital compasses 283, wireless transceivers 260, etc.). In embodiments, for example, a vending machine 100 may have no power and an emergency beacon and/or signal generator 240 may have its own power, e.g., a standalone backup battery 241, which may allow an emergency beacon or signal generator 240 to operate even if a majority or the rest of a vending machine 100 is malfunctioning, down or inoperable. Thus, in these embodiments, an emergency beacon and/or signal generator 240 may be able to provide an indication of an individual's location and/or that an emergency situation is present in such conditions.

In embodiments, a vending machine 100 may comprise one or more cameras and/or imaging devices 245. In embodiments, one or more imaging devices 245 may capture video, images and/or audio of areas surrounding a vending machine 100. In embodiments, one or more camera or imaging devices 245 may capture video, images and/or sounds of individuals within proximity to a vending machine 100. In embodiments, one or more cameras or imaging devices 245 may capture video, images and/or audio of other living organisms (e.g., insect or animals) in areas within proximity to a vending machine 100. In embodiments, one or more cameras or imaging devices 245 may be adjustable because the cameras or imaging devices 245 may be positioned with a gimbal assembly. In embodiments, computer-readable instructions executable by one or more processors may be communicated by a gimbal assembly to move a camera or imaging device in a specified direction. In embodiments, for example, one or more camera imaging devices 245 may work in combination with one or more proximity sensors 275 to determine where an individual is standing or present and computer-readable instructions may be executable by one or more processors to focus the one or more camera imaging devices 245 on an area where an individual is standing or located. In embodiments, one or more imaging devices 245 may provide coverage substantially around an intelligent vending machine. In embodiments, for example, one or more imaging devices 245 may capture images in a 360 degree landscape of an area surrounding a vending machine 100.

In embodiments, images, video and/or audio captured by one or more imaging devices 245 may be received and computer-readable instructions executable by one or more processors may communicate captured images, video and/or audio to a display screen and/or a user interface 150 on a vending machine. In embodiments, one or more imaging devices 245 may capture and communicate images, video and/or audio. In embodiments, computer-readable instructions executable by one or more processors may receive captured images, video and/or audio and communicate the captured images, video and/or audio to one or more wireless transceivers 260 to remote computing devices (e.g., monitoring system computing devices) to provide a visual indication or a visual condition of an individual using or interfacing with a vending machine 100. In embodiments, one or more imaging devices 245 may capture and/or communicate captured images, video and/or sound. In embodiments, computer-readable instructions executable by one or more processors may receive communicated images, video and/or sound and may store the captured images, video and/or sound in one or more memory devices of a vending machine 100. In embodiments, this may be advantageous if outbound communications from the vending machine (e.g., the wireless communication transceivers are not operational or may be malfunctioning) and the stored images, video and/or sound may be retransmitted at a later time. In addition, storing of images, video and/or sound may be utilized as a backup in case there is a dispute regarding the individual and what actions were occurring during a user's interaction with the vending machine.

In embodiments, a vending machine 100 may comprise one or more proximity sensors 275. In embodiments, one or more proximity sensors 275 may be laser sensors, light sensors, line-of-sight sensors, time-of-flight sensors, capacitive sensors, radio frequency sensors and/or infrared sensors or a combination thereof. In embodiments, one or more proximity sensors 275 may have its own power source, e.g., a rechargeable battery or a battery, in order to operate when a majority of the components of the vending machine are not powered. In such embodiments, one or more proximity sensors 275 may detect presence of an object, a living organism and/or a human and send signals to initiate activation of remaining components of a vending machine 100 in response to such detection. In embodiments, computer-readable instructions executable by one or more processors may receive a detection signal from one or more proximity sensors 275 and may communicate messages, instructions and/or commands to one or more rechargeable batteries 205 and/or switching power supplies 206 to activate one or more components in vending machine 100. In embodiments, for example, one or more microphones 243, one or more audio transceivers and/or speakers 249 and/or a display/user interface device 250 may be activated in response to one or more proximity sensors 275 detecting movement. In embodiments, as another example, computer-readable instructions executable by one or more processors 270 may cause one or more processors to communicate a message, command and/or signal to a rechargeable battery 205 to provide power (e.g., voltage and/or current) to specific devices (e.g., one or more wireless communication transceivers 260 and/or solar panels 210 and/or wind blades 220 and turbine 222). In embodiments, detection of movement by one or more proximity sensors 275 may activate one or more imaging devices 245 to generate images to allow determination of a positional location of an object or individual whose movement has activated the one or more proximity sensors 275. In embodiments, one or more proximity sensors 275 may be located on different areas of the vending machine 100 to provide 360 degree coverage of an area surrounding the vending machine. For example, a first proximity sensor may be located on a vending machine front side, a second proximity sensor may be located on a vending machine back side, a third proximity sensor may be located on a vending machine left side and a fourth proximity sensor may be located on a vending machine right side.

In embodiments, a vending machine 100 may comprise one or more audio transceivers 265 and/or one or more speakers 249. In embodiments, digital audio files (e.g., music files and/or audio files) may be received by one or more audio transceivers 265 and may be communicated from one or more audio transceivers 265 to one or more sound reproduction devices (e.g., speakers) 249 for playback. In embodiments, computer-readable instructions 285 stored in one or more memory modules or devices 280 may be executed by one or more processors 270 to communicate audio files (e.g., voice commands and/or voice instructions) to one or more audio transceivers 265 and/or then to one or more speakers 249. In embodiments, some audio files may be stored in one or more memory devices 280. In embodiments, one or more audio transceivers 265 and one or more speakers 249 may allow a remote individual and/or operator to communicate with an individual located at the vending machine. In these embodiments, remote individuals and/or operators may communicate voice files to a vending machine 100 through one or more transceivers 260 and computer-readable instructions executable by one or more processors may communicate these voice files (e.g., communications or messages) to the audio transceiver 265 and then to a speaker (or audio reproduction device) 249. In addition, artificial intelligence and/or machine learning computer-readable instructions executed by one or more processors 270 also may generate voice instructions and/or commands that are communicated to one or more audio transceivers 265 and/or one or more speakers 249 for audible playback. In embodiments, one or more microphones 243 may receive audible or voice instructions and/or commands from an operator and/or user and may convert audible and/or voice instructions into audio files (e.g., analog and/or digital audio files). In embodiments, computer-readable instructions 285 (e.g., a voice-recognition engine) executed by one or more processors 270 may perform voice recognition and extract commands and/or instructions from received audio files. In embodiments, the computer-readable instructions 285 execute by the one or more processors 270 may convert the extracted or recognized commands into messages, commands, instructions, and/or signals to cause actions to be performed on assemblies, components and/or devices. In embodiments, for example, an operator may request that UV sensors 246 be activated to measure UV radiation in an area surrounding a vending machine 100. In embodiments, for example, an operator may audibly request that water be dispensed from the liquid dispenser 225. In this example, computer-readable instructions 285 executed by one or more processors 270 (after receiving a liquid dispending voice command) may generate a command and/or signal to a liquid dispenser 225 to draw liquid from a reservoir 285 in order to fill a container with liquid. Similarly, computer-readable instructions 285 executed by one or more processors 270 may generate a command and/or signal to a product picking assembly 233 to retrieve one or more products from a product storage area 230 and place a selected product into a product dispensing area 235.

In embodiments, a vending machine 100 may comprise one or more wireless transceivers 260. In embodiments, one or more wireless transceivers 260 may be cellular transceivers, wide area network (WAN) transceivers, personal area network (PAN) transceivers and/or 802.11 transceivers. In embodiments, a vending machine 100 may communicate with computing devices (e.g., servers, network computers, desktop computers, etc.) and/or mobile computing devices 263 (e.g., mobile phones, smart phones, tablets, etc.) through one or more wireless transceivers 260. A vending machine 100 may receive instructions, messages and/or commands from remote computing devices and/or mobile computing devices 263 through one or more wireless transceivers 260 and perform actions requested in the instructions, commands and/or messages. In embodiments, commands, instructions and/or messages, audio files, video files and/or image files may be communicated, via one or more wireless communication transceivers 260, to one or more remote computing devices for analysis, extractions, conversion, and/or transfer. For example, audio files may be communicated to a remote server (e.g., a voice recognition server) for voice recognition in order to determine and extract commands that are content of the audio files.

In embodiments, a video and/or image file may captured via one or more imaging devices 245 and communicated via a wireless transceiver 260 to a remote server where, for example, captured videos and/or images may be analyzed to determine a medical condition on a subject and/or operator. For example, an individual may have travelled through the desert and be suffering from heatstroke and found a vending machine as discussed herein. In embodiments, in response to a user selecting a photo option or in response to computer-readable instructions executable by one or more processors, one or more imaging devices 245 may capture a photo and/or video of an individual. In embodiments, computer-readable instructions executable by one or more processors may communicate a captured photo and/or video via one or more wireless transceivers 260 to a remote computing device. In embodiments, a medical professional may review or analyze an image and provide a diagnosis, based at least in part on the received image. In embodiments, software (e.g., computer-readable instructions executable by one or more processors of the remote computing device) may automatically analyze a received image and generate a diagnosis based at least in part of the received image.

In embodiments, a remote computing device (e.g., computer-readable instructions executed by a processor) may communicate commands, messages and/or instructions representative of a diagnosis back to a vending machine 100, which will received the commands, messages and/or instructions via one or more wireless transceivers 260. In embodiments, commands, messages and/or instructions representative of a diagnosis may be communicated to one or more audio transceivers 265 and/or one or more speakers 249 for audible playback and/or to a display 250 for visible display. In embodiments, computer-readable instructions executable by one or more processors on a remote computing device may communicate a diagnosis to emergency service providers (or computing devices associated therewith) if the diagnosis indicates there is a severe and/or emergency condition.

In embodiments, an intelligent vending machine 100 may also include a time-of-flight camera (ToF camera) is a range imaging camera system that resolves distance based on the known speed of light, measuring the time-of-flight of a light signal between the camera and the subject for each point of the image.

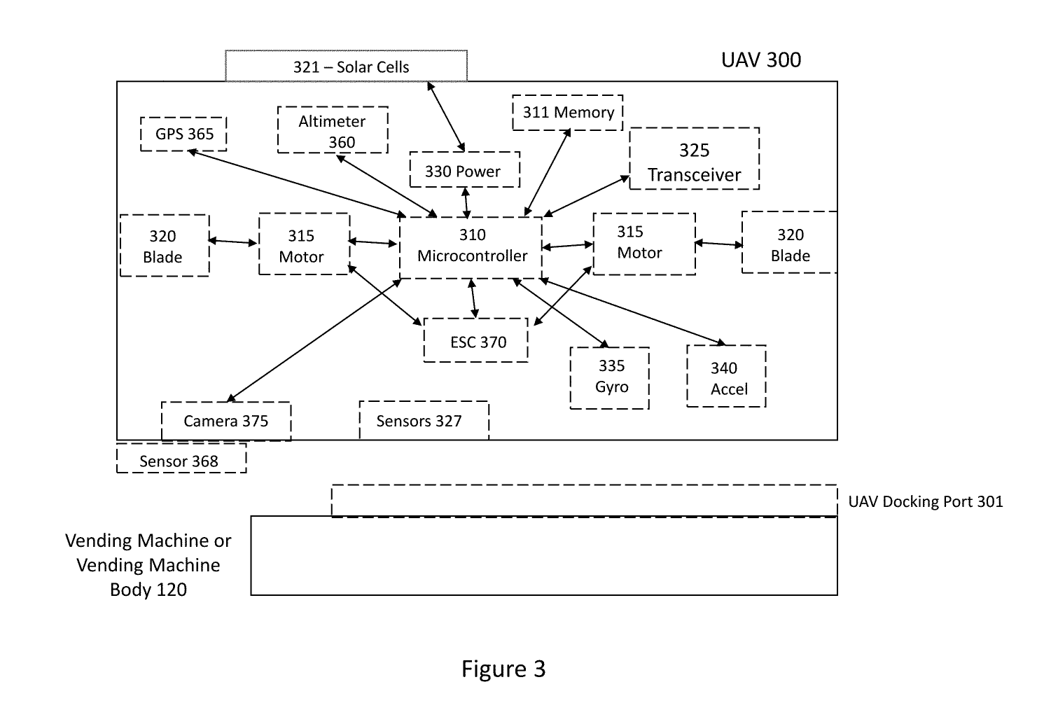

In embodiments, an intelligent vending machine 100 may also comprise a unmanned aerial vehicle (drone) 300. In embodiments, a drone may be referred to as an unmanned aerial vehicle. FIG. 3 illustrates an unmanned aerial vehicle (UAV) according to embodiments. In embodiments, a UAV 300 comprises a frame, a microcontroller board 310, one or more rotors or motors 315, one or more propellers/blades 320, one or more wireless transceivers 325, and/or a power source 330. In embodiments, a UAV 300 may further comprise one or more gyroscopes 335 and/or one or more accelerometers 340. In embodiments, a UAV may comprise an altimeter 360. In embodiments, a UAV may comprise an electronic speed controller (ESC) 370. In embodiments, a UAV 300 may comprise a GPS and/or GLONASS transceiver 365. In embodiments, a UAV may comprise one or more cameras 375.

In embodiments, where an intelligent vending machine 100 comprises a drone or UAV 300, a UAV or drone may be utilized to provide assistance to an individual who may be located at an intelligent vending machine 100 in a remote area. For example, an intelligent vending machine 100 may be located in a remote area of a national park and a hiker may be injured and require assistance. In embodiments, other communication methods utilized by an intelligent vending machine 100 may not be available due to terrain and/or environmental conditions. In embodiments, a UAV or drone 300 may have preprogrammed instructions stored in one or memory devices 311. In embodiments, the preprogrammed instructions may be executed by one or more processors or microcontrollers 310, which cause the processors or other components to execute instructions that may direct and/or instruct a UAV or drone 300 to fly to a specified location utilizing one or more preprogrammed routes. In embodiments, a camera 375 on a UAV 300 may capture an image and/or sound from an individual in distress. In embodiments, a captured image and/or audio, as well as location of a vending machine 100, may be stored in one or memory devices 311 of the UAV 300 and be provided to individuals at locations where the UAV 300 is programmed to fly to and/or land.

In embodiments, an individual or operator located at an intelligent vending machine 100 may utilize a UAV or drone 300 to provide images, sounds and/or videos of an area around an intelligent vending machine 100. For example, if there is civil unrest in an area around an intelligent vending machine or if there are environmental events (e.g., a fire) in an area surrounding an intelligent vending machine 100, an operator and/or individual may communicate instructions, commands, messages and/or signals to a UAV or drone 300 to fly above an area and capture images, sounds and/or videos of a surrounding area. In such circumstances, computer-readable instructions executable by the one or more microcontrollers 310 of the UAV to cause the processor to communicate the captured images, sounds and/or videos via the wireless communication transceiver 325 to remote computing devices utilizing a communications network, e.g., a global communications network, such as the Internet.

FIG. 3 illustrates a UAV device and an intelligent vending machine according to embodiments. In embodiments, a UAV docking port 301 may connect to a UAV device through a latching assembly, a mechanical coupling assembly, and/or through magnetic coupling. In embodiments, a UAV docking port 301 may provide power to a UAV device power source 330 (e.g., a rechargeable battery) through an electrical connection (e.g., wire or connector) and/or through induction coupling (e.g., wireless charging). In embodiments, a UAV docking port 301 may be integrated into and/or located within and/or positioned within an intelligent vending machine 100 or an intelligent vending machine housing 120. In embodiments, a UAV docking port 301 may be placed on a surface of an intelligent vending machine 100 and/or an intelligent machine body 120.

In embodiments, a UAV system may comprise a UAV (e.g., drone) device 300 and/or a UAV docking port 301. In embodiments, a UAV system may depart from a UAV docking port 301 and fly around an area encompassing and/or surrounding a modular vending machine. In embodiments, a UAV device 300 may have a range of 200 meters, 500 meters, 1000 meters and/or 1500 meters from an intelligent vending machine. In other embodiments, depending upon location of a vending machine (e.g., in a really remote area, a UAV device 300 may have a range of 5 miles up to several hundred miles.

In embodiments, for example, a UAV device 300 may comprise one or more environmental sensors 327. In embodiments, one or more environmental sensors 327 may capture sensor measurements and communicate the environmental sensor measurements to a microcontroller and/or processor 310. In embodiments, computer-readable instructions executable by one or more microcontrollers 310 may cause a microcontroller to communicate captured environmental sensors measurements to a vending machine 100 and/or remote computing devices utilizing the UAV wireless communication transceiver 325. In embodiments, one or more environmental sensors 327 may comprise one or more air quality sensors, which may be installed on a UAV device 300. In embodiments, a UAV 300 may be launched into an the air and/or environment and a UAV 300 environmental sensor 327 make take air quality measurements during flight of the UAV device 300. In embodiments, computer-readable instructions executable by one or more processors 310 may cause a processor to transmit and/or communicate captured measurements and/or readings from an air quality sensor to a vending machine 100. In embodiments, computer-readable instructions 285 executable by one or more processors 270 may receive captured sensor measurements from a UAV 300 and may 1) store captured sensor measurements in one or more memory devices 280; 2) combine captured sensor measurements from UAV sensors 327 with captured sensor measurements from vending machine sensors 246 to obtain a better picture of environmental conditions around a vending machine; and 3) analyze captured sensor measurements for UAV sensors 327 and/or vending machine sensors 246 to determine if unfavorable conditions exist and if additional action by the vending machine may be necessary. In embodiments, additional action may be generating messages to a display or user interface 150 and/or audio transceivers 265 and speakers 249. In embodiments, computer-readable instructions 285 executable by one or more controllers/processors 270 may cause a processor to communicate commands, instructions, messages and/or signals to other components to activate and/or deactivate based on received sensor readings. Placing environmental sensors on a UAV device 300 provides an advantage over just having environmental sensors on a vending machine 100 because obtaining or capture sensor measurements from a vending machine 100 and a traveling (e.g., flying) UAV device provides more accurate and comprehensive sensor readings (e.g., measurements may be taken at a number of locations at rather than only an exact location at where a vending machine is installed or located. In addition, more accurate and comprehensive sensor readings may be obtained at locations unreachable from a ground location (e.g., at higher elevations and/or at locations obscured and/or walled off from a place where an intelligent vending machine is installed).

In embodiments, a UAV 300 may be controlled by instructions transmitted by a computing device (e.g., a computing device in a mobile computing device 263 and/or a computing device in an intelligent vending machine). In embodiments, a mobile computing device 263 may communicate with a UAV or drone 300 utilizing personal area network protocols including but not limited to Bluetooth, Zigbee, etc. In embodiments, computer-readable instructions stored in a memory of a computing device and executable by a processor of a mobile computing device 263 (e.g., SMARTSHADE and/or SHADECRAFT software) may control operations of a UAV device/drone 300. In embodiments, operations may include guiding movement of a drone, communicating measurements and/or data from a drone, activating/deactivating sensors on a drone, and/or activating/deactivating one or more cameras 375 on a drone. For example, in embodiments, a UAV device 300 may comprise one or more camera devices 375. In embodiments, a camera device 375 may capture images, video and/or sound of the environment surrounding a drone/UAV 300 and may transmit and/or communicate images back to a mobile computing device 263 and/or other component of a modular umbrella vending machine 300.

In embodiments, a computing device may be a mobile computing device 263 having computer-readable instructions executed by a processor to interface and/or control an intelligent vending machine and/or a UAV. In embodiments, a computing device may be an intelligent vending machine computing device having computer-readable instructions stored thereon and executable by a processor. In embodiments, an intelligent vending machine may comprise a user interface (e.g., on a display) that may control and/or interface to a UAV 300. In embodiments, a computing device may comprise a wireless communication transceiver that communicates with one or more transceivers 325 in a UAV 300. In embodiments, a mobile computing device 263 may communicate with a cloud-based server, which may communicate with one or more transceivers in a UAV 300.

In embodiments, a power source 330 may be a rechargeable battery. In embodiments, a rechargeable battery may allow for up to 12 hours of operation. In embodiments, a UAV 300 may comprise one or more solar panels or cells 321. In embodiments, one or more solar panels or cells 321 may convert sunlight into electricity which may be transferred to a rechargeable battery 330 in order to chare a rechargeable battery 300. In embodiments, a UAV 300 may be powered via UAV docking port 301 (and a vending machine rechargeable battery 205).

In embodiments, a UAV 300 may comprise one or more microcontrollers (e.g., a single board microcontroller) 310. In embodiments, one or more microcontrollers 310 may include a processor, a memory, computer-readable instructions stored in one or more memory devices 311 and executable by the one or more processors/microcontrollers 310. In embodiments, a microcontroller 310 may control operations of one or more motors 315 of the UAV (and thus blades and/or propellers 320), may communicate and/or interface with inertial components such as gyroscopes 335 and/or accelerometers 340, may communicate and/or interface with landing sensors 368 and/or other sensors, may communicate and/or interface with cameras 375, and/or may communicate and/or interface with a power source 330 (e.g., rechargeable battery) and/or one or more solar cells or arrays 321. In embodiments, a single board microcontroller may be an Arduino board, a DJI A2 or other similar controllers. In embodiments, a UAV may also comprise an electronic speed controller (ESC) 370. In embodiments, an electronic speed controller 370 may be integrated into or on a same board as a microcontroller. In embodiments, a ESC 370 may determine and control speed, velocity and/or acceleration of a UAV by communicating messages, instructions, signals and/or commands to one or more motors 315 to tell motors how fast to operate and spin propeller blades 320. In embodiments, an ESC 370 may provide different speeds to different motors in order to move in specific directions. In embodiments, a microcontroller 310 may communicate with an ESC 370 to determine and/or control speed, velocity and/or acceleration of a UAV 300.

In embodiments, an inertial measurement unit may comprise one or more gyroscopes 335 and/or one or more accelerometers 340. In embodiments, UAVs 300 may be exposed to many external forces (wind, rain, physical objects, etc.) coming from different directions. In embodiments, external forces may impact a drone's yaw, pitch and/or roll, and thus impact a UAV's flight movement. In embodiments, one or more gyroscopes 335 detect such changes in position (e.g., changes in yaw, pitch and roll) and communicate this information to a microcontroller 310, which can then interface with an electronic speed control (ESC) 370, motors 315 and/or propellers/blades 320. In embodiments, gyroscopes feedback information on position hundreds of time each second. In embodiments, one or more accelerometers 340 may also measure changes in an UAV's 300 orientation relative to an object's surface (e.g., Earth's surface). In embodiments, one or more accelerometers 340 communicate measurement changes in a UAV's orientation to a microcontroller 310, which in turn may communicate messages, commands and/or instructions to ESCs 370, which in turn may communicate messages, commands and/or instructions to motors 315 and/or propeller/blades 320.

In embodiments, a UAV may comprise an altimeter 360. In embodiments, an altimeter 360 may measure an altitude of a UAV and may communicate altitude measurements to a microcontroller 310. In embodiments, a microcontroller or controller or processor 310 (e.g., computer-readable instructions executable by one or more UAV microcontroller 310) may verify, compare and/or check altitude measurements against desired altitude measurements. In response to the verification and/or comparison, a microcontroller 310 may which in turn may communicate messages, commands and/or instructions to ESCs 370, which in turn may communicate messages, commands and/or instructions to motors 315 and/or propeller/blades 320.

In embodiments, a UAV 300 may comprise a GPS or GLONASS transceiver 365. In embodiments, a GPS transceiver 365 may capture and/or calculate position readings for a UAV 300 and communicate these measurement and/or calculated positions to a microcontroller 310. In embodiments, a microcontroller 310 may utilize GPS measurements and/or readings to determine a geographic location of a UAV 300. In embodiments, a microcontroller 310 may utilize GPS measurements to identify take off positions and/or landing positions. In embodiments, a GPS transceiver 365 may be located on a microcontroller 310. In embodiments, a GPS transceiver 365 may be located in an inertial measurement unit.

In embodiments, a UAV 300 may comprise landing sensors 368. In embodiments, landing sensors 368 may be light-based sensors and/or ultrasonic sensors. In embodiments, landing sensors 368 may be located on a bottom surface of a UAV 300. In embodiments, landing sensors 568 may communicate measurements and/or readings regarding a landing surface (e.g., is a landing surface present, how far is it away (based on sound and/or light reflection)) to a microcontroller 310. In embodiments, a microcontroller 310 (e.g., computer-readable instructions executable by the one or more UAV microcontrollers) may communicate messages, commands and/or instructions to ESCs 530, which in turn may communicate messages, commands and/or instructions to motors 315 and/or propeller/blades 320 to move a UAV 300 to a landing position (e.g., a modular umbrella system landing spot and/or landing dock).

In embodiments, a UAV 300 may comprise one or more wireless transceivers 325. In embodiments, a wireless transceiver 325 may communicate commands, instructions, signals and/or messages between wireless transceivers in an intelligent vending machine 100. In embodiments, a wireless transceiver 325 may communicate commands, instructions, signals and/or messages between wireless transceivers in a mobile computing device 263 such as a smartphone, a tablet, a controller, a laptop computer etc. In embodiments, computer readable instructions, stored on a memory of a mobile computing device 263 (and or modular umbrella system) may be executed on a processor (e.g., in a SMARTSHADE application) and one option in a software application may be UAV operation and/or control. In embodiments, for example, SMARTSHADE software application may comprise, among other things, a UAV or drone icon, which if selected, further presents various modes of UAV operation and control. In embodiments, a SMARTSHADE software application may provide instructions as to flight of a UAV, take off and/or landing of a UAV, movements in direction of a UAV, activation/deactivation of a UAV camera, and activation/deactivation of other sensors and/or components of a UAV. In embodiments, a SMARTSHADE application may communicate messages, instructions, commands and/or signals utilizing a wireless transceiver in a mobile computing device 263 and a wireless transceiver in a UAV.

In embodiments, a UAV 300 may comprise one or more cameras 375. In embodiments, one or more cameras may be placed on a bottom surface of a UAV 300 to capture images, sounds and/or videos of an area adjacent to and/or surrounding an intelligent vending machine. In embodiments, a microcontroller 310 may activate and/or deactivate one or more cameras 375. In embodiments, one or more cameras 375 may capture images, sounds and/or videos and may communicate captured images, sounds and/or videos to a microcontroller 310, which may store captured images, sounds and/or videos in a memory of a UAV and/or a microcontroller 310. In embodiments, a microcontroller 310 may communicate and/or transfer captured images to a computing device in an intelligent vending machine 100, which in turn may store captured images in a memory of an intelligent vending machine and/or transfer captured images, video and/or sound to other computing devices (e.g., devices in a cloud) and/or mobile computing devices 263 linked to an intelligent vending machine (e.g., mobile computing devices 263 utilizing and executing SMARTSHADE software). In embodiments, a UAV 300 may communicate captured images, video and/or sound via a wireless transceiver 325 to a mobile computing device 263 (which utilizes its own wireless transceiver for communication) without first communicating captured images, videos and/or sound to an intelligent vending machine 100. In other words, a UAV 300 may transfer and/or communicate images captured by its camera 375 directly to a mobile computing device 263 or indirectly to a web server which in turn communicates the images, videos and/or sound to the mobile computing device (without passing through an intelligent vending machine).

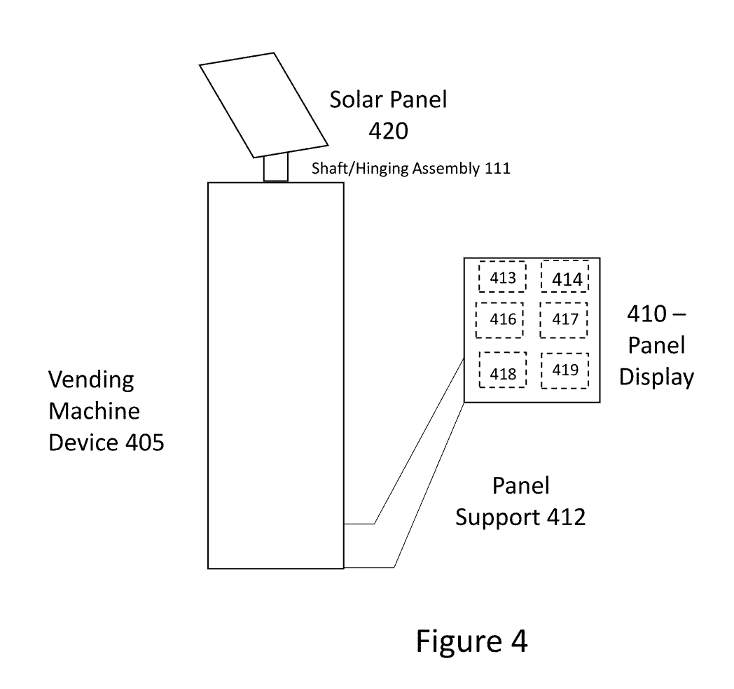

FIG. 4 illustrates an intelligent vending machine according to embodiments. FIG. 4 illustrates a side view of an intelligent vending machine. In embodiments, an intelligent vending machine 400 comprises one or more user interface panel displays 410, one or more panel supports 412, an intelligent vending machine body 405 and one or more solar panels 410. In embodiments, one or more support panels 410 may be connected, coupled and/or attached to a vending machine body 410 via one or more support posts 422 and/or support shafts. In embodiments, one or more support shafts and/or support posts 422 may rotate one or more solar panels 420 to track the sun. In embodiments, one or more motor assemblies may cause solar panels 420 to rotate about an azimuth axis and/or may causes solar panels to expand and/or elevate. In embodiments, a control panel for operating an intelligent vending machine 400 may be positioned in one or more user interface displays or input screens 420. In embodiments, the one or more user interface displays or input screens 420 may be positioned away at a distance from a vending machine body 405. This may provide an advantage of having a user not being positioned directly next to the vending machine. For example, if a camera is capturing an image of a user or operator, a camera positioned in a vending machine body 405 may capture a larger image of a user and may provide a more accurate image of a user's condition. In addition, if a vending machine is utilizing voice recognition of user's commands, having a user speak at a distance away from the moving mechanisms of the intelligent vending machine and not having the noise from the moving mechanisms or speakers interfere with the voice recognition. In embodiments, one or more microphones, one or more speakers, and computer-readable instructions executable by a processor to perform voice recognition may be located in the one or more panel displays or input screens 410. In embodiments, it may be one or more microphones 413 and one or more speakers 414 may be located in a panel support 412 and/or a panel display or input screen 410 to keep these components away from noise-making components which may impact use of microphones 413 (because of background noise being present when audio commands and/or messages are being captured) and sound reproduction devices 414 (due to too much noise being present when audio is being reproduced). In embodiments, a touch screen display and/or an LCD display may be integrated into one or more panel displays. In embodiments, one or more panel displays 410 and/or a panel support 412 may comprise one or more processors 416 and computer-readable instructions that may be executable by the one or more processors 416 to perform operation and/or activation of other components in one or more panel displays or input units 410 or panel supports 412. In embodiments, one or more panel displays or input units 410 or panel support 412 may comprise one or more cameras 417 to capture images in an area surrounding in front of or to the side of one or more panel displays 410/panel support 412 and/or one or more environmental sensors 419 to capture environmental measurements in areas surrounding the vending machine. In embodiments, one or more panel displays or input units 410 or a panel support 412 may comprise one or more wireless transceivers 418 to communicate with external computing devices, portable computing devices and/or other wireless transceivers in an intelligent vending machine device 405.

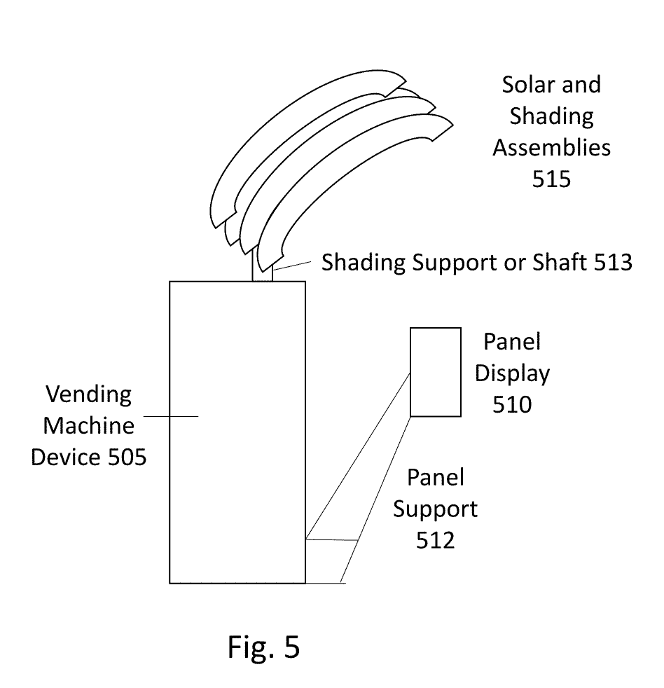

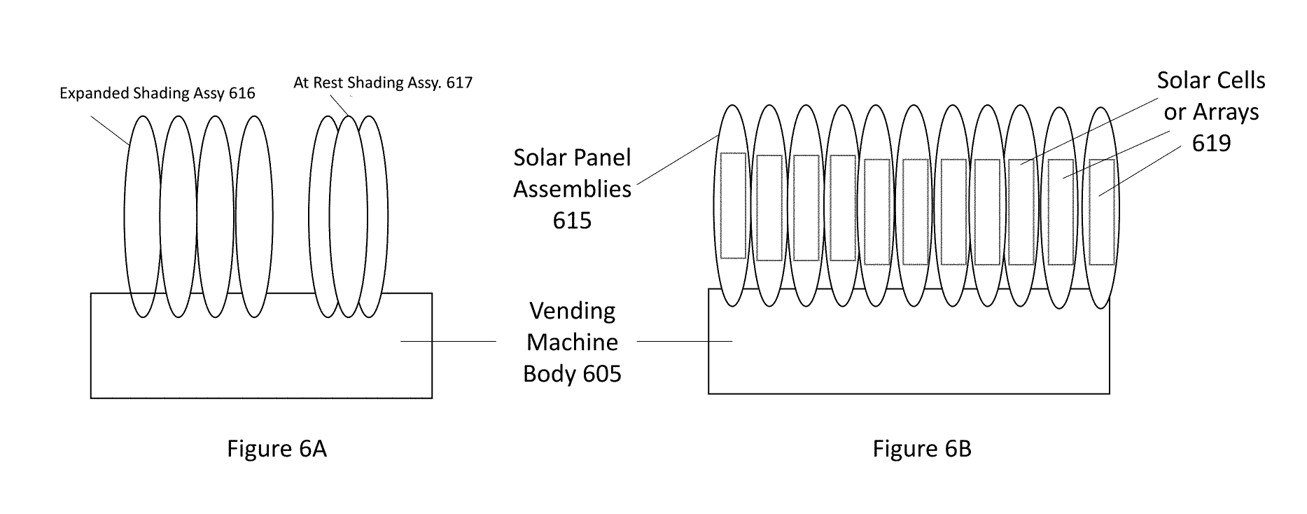

FIG. 5 illustrates an intelligent vending machine with one or more solar and/or shading assemblies according to embodiments. In embodiments, an intelligent vending machine 500 comprises a vending machine body 505, one or more panel supports 512, one or more panel displays or input devices 510 and one or more solar and shading assemblies 515. FIGS. 6A and 6B illustrate two possible configurations of one or more solar and shading assemblies 515 according to embodiments. In embodiments, such as illustrated in FIG. 5, one or more solar and shading assemblies 515 may be mounted to a support post(s) 513 and/or support shaft(s) 513 and may be rotatable about an azimuth axis (as described earlier with respect to FIG. 1). In embodiments, one or more solar and shading assemblies 515 may be mounted on top of a vending machine body 505. In embodiments, one or more solar and/or shading assemblies 515 may generate electrical energy from solar power in addition to providing shade for users and/or operators of an intelligent vending machine 500. In embodiments, such as illustrated in FIG. 6A, one or more solar and/or shading assemblies 615 may be grouped in two sections 616 and 617, where each of the sections of solar and/or shading assemblies 615 may be independently moved and expanded. This provides a user and/or operator with an ability to only expand one group of solar and/or shading assemblies 616 expanded while leaving the other group of solar and/or shading assemblies 617 in a rest or non-expanding positioned. In embodiments, one or more solar and shading assemblies may be in a position overlapping each other. In embodiments, this may be an initial or at rest position. FIG. 6B illustrates a position where a plurality of solar and/or shading assemblies 615 are deployed according to embodiments. In embodiments, this position may be referred to as fully expanded and/or expanded. In embodiments, each of a plurality of solar and/or shading assemblies 615 may be positioned adjacent to each other and may not be overlapping. In this example embodiment, there is very little or no space between the solar panel and/or shading assemblies 615 and thus a large amount of shade can be provided to users that are standing underneath the solar panel and shading assemblies 615. In embodiments, FIG. 6B illustrates a position where a large amount of sun may be gathered by solar cells or arrays 619 and also a large amount of shade may be provided to a user and/or operator because the one or more solar panel and shading assemblies 615 have little or no space between them. In embodiments, a deployment of one or more shading or solar assemblies in a configuration as is illustrated in FIG. 6B, may resemble winds of a bird and/or wings of a hawk.

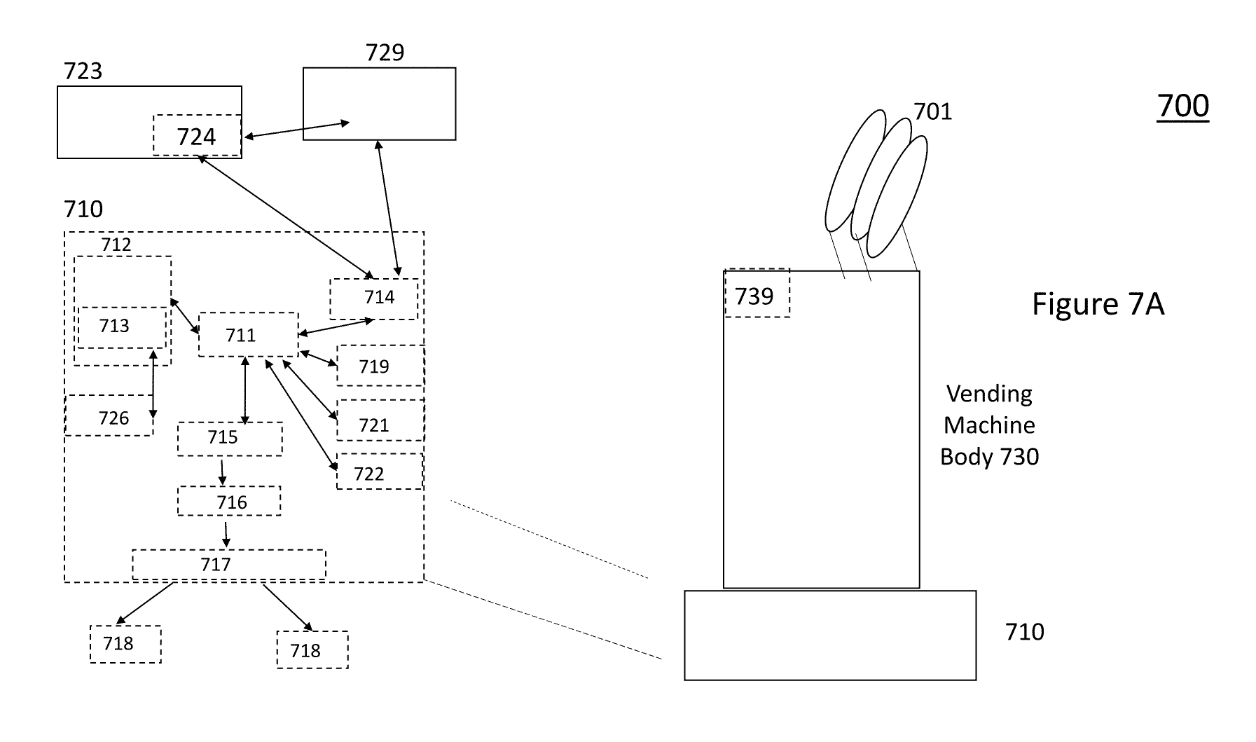

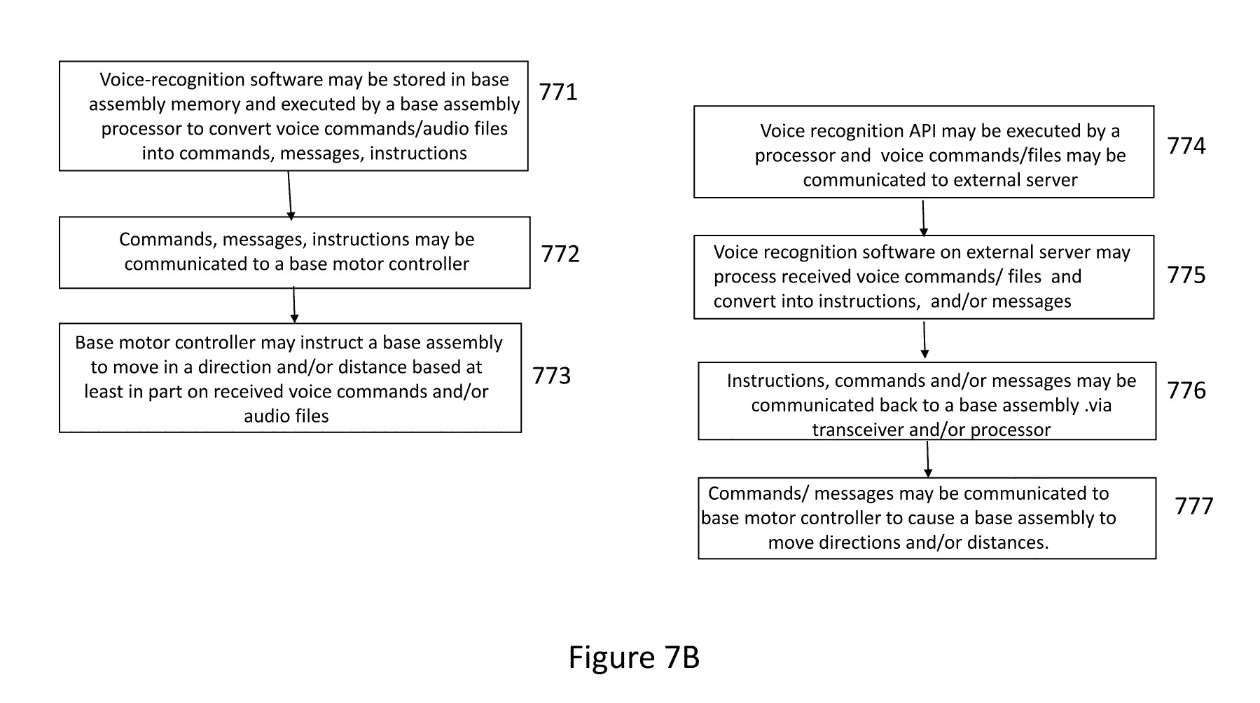

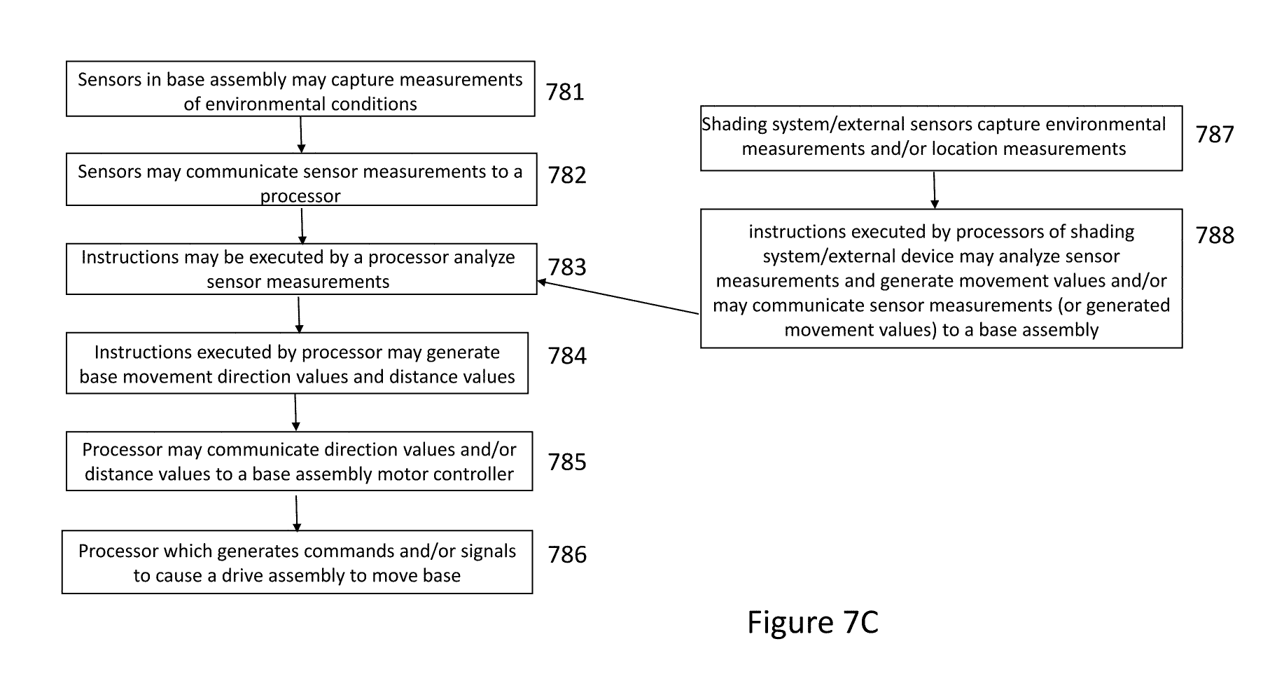

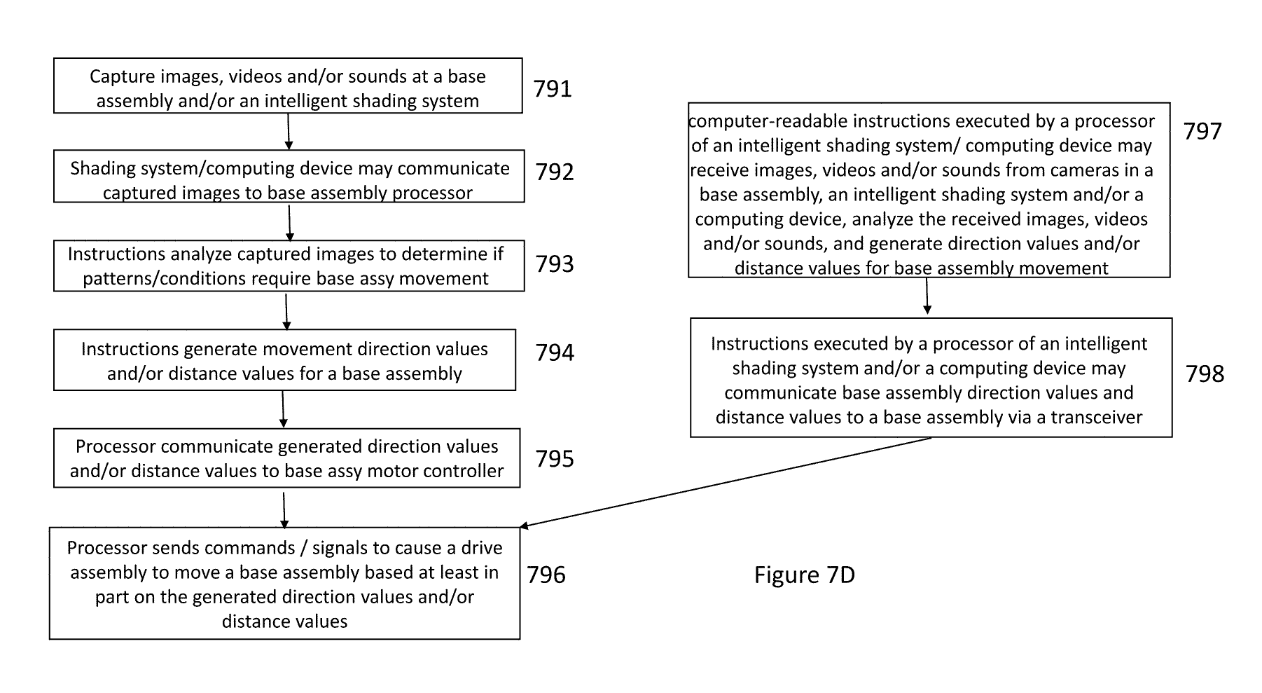

FIG. 7A illustrates an intelligent vending machine with a movable base assembly according to embodiments. FIGS. 7B-7D illustrate methods of a movable base assembly moving an intelligent vending machine according to embodiments. In embodiments, it may be desirable for an intelligent vending machine to move to escape harsh environmental conditions, to capture a larger amount of solar energy, to be more visible in an environment in which it is located, or to move closer to a user and/or operator that may be in distress or needs attention. FIG. 7A illustrates an intelligent vending machine with a movable base assembly according to embodiments. In embodiments, an intelligent vending machine 700 may comprise a movable base assembly 710, a vending machine body 730 and/or one or more solar panels or solar assemblies 701 which may also be shading assemblies. In embodiments, a movable base assembly 710 may comprise, a base motor controller PCB 715, a base motor 716, a drive assembly 717 and/or one or more wheels (or base driving assemblies) 718. In embodiments, a base assembly 710 may comprise one or more environmental sensors 721 and/or one or more directional sensors 722. In embodiments, a base assembly 710 may also comprise one or more proximity sensors 719. In embodiments, a base assembly 710 may comprise one or more processor or controllers 711, one or more memory modules or memories 712 and/or computer readable instructions 713, where the computer-readable instructions are fetched, read and/or accessed from the one or more memory modules or memories 712 and executed by the one or more processor or controllers 711 to perform a number of functions and/or processes. In embodiments, a base assembly 710 may comprise one or more wireless transceivers 714. In embodiments, a base assembly 710 may comprise one or more cameras 726.

In embodiments, a base assembly 710 (and thus an intelligent vending machine 700) may move around a surface (e.g., a ground surface, a floor, a patio, a deck, and/or outdoor surface) based at least part on environmental conditions. In embodiments, a base assembly 710 may move based on pre-programmed settings or instructions stored in one or more memories 712 of a base assembly 710. In embodiments, a base assembly 710 (and intelligent vending machine 700) may move around a surface in response to commands, instructions, messages or signals communicated from portable computing devices (e.g., mobile phone, smart phone, laptops, mobile communication devices, mobile computing devices and/or tablets). In embodiments, a base assembly 710 may move around a surface in response to voice commands. In embodiments, for example, a base assembly 710 may move to track and/or adjust to environmental conditions (e.g., the sun, wind conditions, temperature conditions) and/or may move in response to an individual's commands. In embodiments, a base assembly 710 (and intelligent vending machine) may move around a surface based at least in part (or in response to) sensor readings. In embodiments, a base assembly 710 may move around a surface based at least in part on images captured and received by cameras located on a base assembly 710, an intelligent vending machine 1700, and/or a portable computing device and/or a server (or computing device) 729.

In embodiments, computer-readable instructions 713 stored in a memory 712 of a base assembly 710 may be executed by one or more processors 711 and may cause movement of the base assembly based on or according to pre-specified conditions and/or pre-programmed instructions. In embodiments, for example, a base assembly 710 of an intelligent vending machine 700 may move to specified coordinates at a specific time based on the stored computer-readable instructions 713 stored in one or more memories 712. For example, a base assembly 710 may move 10 feet to the east and 15 feet to the north at 8:00 am based on stored computer-readable instructions 713. In embodiments, for example, a base assembly 710 (and thus a vending machine) may move to specified coordinates based upon other conditions (e.g., specific days, temperature, other devices being in proximity) that may match conditions or be predicted on conditions stored in the computer-readable instructions 713 stored in the one or more memories 712. For example, a base assembly 710 may move if it is 9:00 pm and/or if it is a Saturday.

In embodiments, a motor controller in an intelligent vending machine 700 may communicate instructions, commands, signals and/or messages related to or corresponding to base assembly movement directly to a base motor controller 715 and/or indirectly through a processor or controller 711 to a base motor controller 715. For example, a motor controller in an intelligent vending machine may communicate instructions and/or messages to a base motor controller 715 which may result in a base assembly 710 moving 20 feet sideways. In embodiments, communication may pass through a transceiver 714 to a base motor controller 715. In embodiments, communications may pass through a base assembly controller or processor 711 to a base motor controller 715. In embodiments, computer-readable instructions stored on one or more memory modules or memories of an integrated computing device (e.g., 136 in FIG. 1) of an intelligent vending machine 700, may cause a processor in an intelligent vending machine 700 to receive one or more measurements from one or more sensors (including wind, temperature, humidity, air quality, directional sensors (GPS and/or digital compass)) in an expansion sensor assembly 760; analyze the one or more received measurements; generate commands, instructions, signals and/or messages; and communicate such commands, instructions, signals and/or messages to a base assembly 710 to cause a base assembly 710 to move. For example, based on wind sensor or temperature sensor measurements, computer-readable instructions executed by a processor of an integrated computing device 136 may communicate messages to a base motor controller 715 in a base assembly 710 to cause the base assembly 710 to move away from a detected wind direction and/or condition. For example, based on received solar power measurements (from one or more solar panel assemblies) and/or a directional sensor reading (e.g., a digital compass reading or GPS reading), a processor executing computer-readable instructions in a computing device may communicate messages and/or instructions to a base motor controller 715 to cause a base assembly 710 to automatically move in a direction where solar panels may capture more solar power. This provides an intelligent vending machine with an advantage because not only can an intelligent vending machine may rotate towards a light source (e.g., via an azimuth motor) and/or change elevation to move toward a light source (e.g., via an elevation motor), an entire intelligent vending machine also has an ability to move to an area where no obstacles or impediments are present, or where no unfavorable conditions are present because the base assembly 710 is movable from one location to another.

In embodiments, a portable computing device 723 (e.g., smart phone, mobile communications device, a laptop, and/or a tablet) and/or a computing device 729 may transmit commands, instructions, messages and/or signals to a base assembly 710 identifying desired movements of a base assembly 710. In embodiments, a portable computing device 723 and/or a computing device 1729 may comprise computer-readable instructions stored in a memory of a portable computing device 723 or computing device 729 and executed by a processor (e.g., SMARTSHADE software) that communicates with an intelligent vending machine 700 as is described supra herein. In embodiments, computer-readable instructions executed by a processor of a mobile computing device 723 may be part of a client-server software application that also has computer-readable instructions stored on a server and executed by a processor of a server (e.g., computing device 729). In embodiments, computer-readable instructions executed by a processor of a mobile computing device 723 may be part of a client-server software application that also has computer-readable instructions stored on a memory and executed by a processor of an integrated computing device 136 of an intelligent vending machine 700. In other words, not all of the computer-readable instructions may be stored on a mobile computing device 723. In embodiments, computer-readable instructions executed by a processor of a mobile computing device 723 may communicate instructions, commands and/or messages directly to a base assembly 710 via a wireless transceiver (e.g., a wireless transceiver 724 on a mobile computing device 723 may communicate commands and/or messages to a transceiver 714 on a base assembly 710).

In embodiments, voice commands may be converted on a mobile computing device 723 and instructions and/or messages based at least in part on the voice commands may be transmitted (e.g., via a wireless transceiver 724) to a base assembly motor controller 715 directly (e.g., through a wireless transceiver 714), or indirectly via a wireless transceiver 714 and/or a base assembly processor 711 to automatically move a base assembly 710 in a specified direction. In embodiments, instructions, messages and/or signals corresponding to voice commands and/or audio files may be communicated in commands, instructions and/or messages to a base assembly motor controller 715 directly, or indirectly as described above. In embodiments, where audio files are received, computer-readable instructions 713 stored in a base assembly memory 712 may be executed by a base assembly processor 711 to convert the voice commands into instructions, signals and/or messages recognizable by a base assembly motor controller 715. In embodiments, computer-readable instructions executed by a processor on a mobile computing device 723 may present a graphical representation of a base assembly 710 on a mobile computing device display. In embodiments, a mobile computing device 723 may receive commands via a user interface 150 from a user representing directions and/or distance to move a base assembly (e.g., a user may select a graphic representation of a base assembly on a display of a mobile computing device and indicate that it should move to a left or east direction approximately 15 feet) and computer-readable instructions executed by a processor a mobile computing device 723 may communicate commands, instructions and/or messages representative of a base assembly movement directions and/or distance directly and/or indirectly to a base assembly motor controller 715 to cause movement of a base assembly 710 in the selected direction and/or distance. This feature may provide an advantage of independently moving a base assembly 710 (and an intelligent vending machine 700) from a remote location without having to be next to or in proximity to a base assembly. In embodiments, a transceiver 714 may be a WiFi (e.g, an 802.11 transceiver), a cellular transceiver, and/or a personal area network transceiver (e.g., Bluetooth, Zigbee transceiver) so that a mobile computing device 723 (and its wireless transceiver 724) may communicate with a base assembly 710 via a number of ways and/or protocols. In embodiments, a mobile computing device 723 may utilize an external server (e.g., a computing device 729) and/or an intelligent vending machine 700 (e.g., an integrated computing device in a vending machine 700) to communicate with a base assembly 710.

In embodiments, a base assembly 710 may move in response to voice commands. In embodiments, voice-recognition software (e.g., computer-readable instructions) may be stored in a memory 712 of a base assembly and executed by a base assembly processor 711 to convert 771 actual voice commands (spoken by an operator) or received voice audio files into messages, instructions and/or signals which can then be communicated 772 to a base motor controller 715. In embodiments, a base motor controller 715 may generate commands or messages and communicate commands or messages 773 a base assembly 710 to move in a direction and/or distance based at least in part on received voice commands and/or audio files. In embodiment, a voice recognition application programming interface (API) may be stored in a memory 712 of a base assembly 710. In embodiments, a voice recognition API may be executed by a processor 711 of voice commands and/or voice audio files from a base assembly may be communicated 774 to an external server (e.g., via a wireless transceiver 714) or other network interface. In embodiments, voice recognition software may be present or installed on an external server (e.g., computing device 729) and may process 1775 the received voice commands and/or voice audio files and convert the processed voice files into instructions and/or messages, which may then be communicated 1776 back to a base assembly 710. In embodiments, the communicated instructions, commands and/or messages from an external voice recognition server (e.g., computing device 729) may be received at a base assembly 710 and transferred and/or communicated (e.g., via a transceiver 714 and/or a processor 711) 777 to a base motor controller 715 to cause a base assembly 710 to move directions and/or distances based at least in part on the received voice commands. Similarly, voice recognition of received voice commands and/or audio files, as discussed above, may be performed at an intelligent vending machine 700 (e.g., utilizing computer-readable instructions stored in memories of a computing device) and/or at a mobile computing device 723 (e.g., utilizing computer-readable instructions stored in memories of a mobile computing device 723) or combination thereof, and converted instructions, commands and/or messages may be communicated to a base motor controller 715 to cause movement of a base assembly in specified directions and/or distances. The ability of a base assembly 710 to move in response to voice commands allows an advantage of a vending machine to move quickly (and be communicated with via a variety of interfaces) with specific and customizable instructions without having a user physically exert themselves to move an umbrella and/or vending machine to a proper and/or desired position.

In embodiments, a base assembly 710 may comprise one or more sensors (e.g., environmental sensors 721 (wind, temperature, humidity and/or air quality sensors); direction sensors 722 (e.g., compass and/or GPS sensors); and/or proximity sensors 719. In embodiments, in addition or as an alternative, an intelligent vending machine 700 may comprise one or more environmental sensors 721, directional sensors 722 and/or proximity sensors 719 located on a base assembly 710 (e.g., on a surface of a base assembly) and/or within a base assembly 710. In embodiments, in addition or as an alternative, an external hardware device (e.g., a drone and/or a portable computing device 723) or other computing devices (e.g., that are part of home security and/or office building computing systems or computing device 729) may comprise directional sensors, proximity sensors, and/or environmental sensors that communicate with an intelligent vending machine 700 and/or a base assembly 710. In embodiments, sensors 722 located within a base assembly 710 may capture 781 measurements of environmental conditions and/or location information adjacent to and/or surrounding the base assembly 710. In embodiments, one or more sensors 722 may communicate 782 sensor measurements to a processor and/or controller 711. In embodiments, computer-readable instructions 713 stored in a memory 712 of a base assembly may be executed by a processor and/or controller 711 and may analyze 783 sensor measurements. In embodiments, based on the analyzation of sensor measurements, computer-readable instructions 713 may generate 784 movement direction values and distance values and/or instructions for a base assembly 710. In embodiments, computer-readable instructions executed by a processor 711 may communicate 785 the generated direction values and/or distance values and/or instructions to a base assembly motor controller 715, which generates messages, commands, and/or signals to cause 786 a drive assembly (e.g., a motor, shaft and/or wheels or a motor, shaft and/or treads) to move a base assembly 710 based at least in part on the generated direction values and/or distance values and/or instructions.

In embodiments, environmental sensors and/or directional sensors may be located on an intelligent vending machine 700, external hardware devices (e.g., portable computing device 723) and/or external computing devices (e.g., computing device or server 729). In embodiments, intelligent vending machine sensors and external device sensors may capture 787 environmental measurements (e.g., wind, temperature, humidity, air quality) and/or location measurements (e.g., latitude and/or longitude; headings, altitudes, etc.) and may communicate captured measurements or values to processors and/or controllers in respective devices (e.g., intelligent vending machine 700, portable computing device 723 or external computing devices 729). In embodiments, computer-readable instructions executed by processors and/or controllers an intelligent vending machine, portable computing device and/or external computing device may analyze sensor measurements and generate movement values or instructions (e.g., direction values and/or distance values) and/or may communicate sensor measurements (or generated movement values or instructions) 788 to a base assembly 710 utilizing transceivers in intelligent vending machines, portable computing devices (e.g., transceiver 723) and/or external computing devices (e.g., computing device 729) and one or more base assembly transceivers 714. In other words, either sensor measurements, analyzed sensor measurements and/or movement instructions may be communicated to a base assembly 710. In embodiments, some or all of the steps of 783-786 may be repeated for the received sensor measurements and/or movement instructions received from intelligent vending machine sensors, external hardware device sensors, portable computing device sensors and/or external computing device sensors, which results in movement of a base assembly 710 based on the received sensor measurements or instructions.

In embodiments, a base assembly 710 may comprise one or more cameras 726 and may utilize pattern recognition and/or image processing to identify potential base movement. In embodiments, in addition or as an alternative, an intelligent vending machine 700 may comprise one or more cameras 739 located thereon and/or within and may communicate images, video and/or sound with a base assembly 710. In embodiments, in addition or as an alternative, an external hardware device (e.g., a drone and/or a portable computing device 723) or other computing devices 729 (e.g., that are part of home security and/or office building computing systems) may comprise one or more cameras that communicate images, videos and/or sounds/audio to an intelligent vending machine 700 and/or a base assembly 710. In embodiments, one or more cameras 726 located within a base assembly 710, one or more cameras 1739 in an intelligent vending machine 700, a portable computing device 723 and/or a remote computing or hardware device may capture 791 images, videos and/or sounds adjacent to and/or surrounding a base assembly 710 and/or an intelligent vending machine 700.

In embodiments, one or more cameras 726 in a base assembly 710, one or more cameras in an intelligent vending machine, portable computing device 1723 and/or remote computing device (e.g., computing device 729) may communicate 792 captured images to a processor and/or controller 711 in a base assembly 710. In embodiments, computer-readable instructions 713 stored in a memory 712 of a base assembly 710 may be executed by a processor and/or controller 711 and may analyze 793 captured images to determine if any patterns and/or conditions are recognized as requiring movement of an intelligent vending machine 700 via movement of a base assembly 710. In embodiments, based on the analyzation and/or pattern recognition of captured images, video and/or sounds, computer-readable instructions 713 may generate 794 movement direction values and/or distance values and/or instructions for a base assembly 710. In embodiments, computer-readable instructions executed by a processor 711 may communicate 795 generated direction values and/or distance values and/or instructions to a base assembly motor controller 715, which generates messages, commands, and/or signals to cause 796 a drive assembly (e.g., a motor, shaft and/or wheels or a motor, shaft and/or treads) to move a base assembly 710 based at least in part on the generated direction values and/or distance values. In embodiments, computer-readable instructions executed by a processor of an intelligent vending machine, a portable computing device 723 and/or a computing device 729 may receive images, videos and/or sounds from cameras on a base assembly 710, an intelligent vending machine 700, a portable computing device 723 and/or a computing device 729, analyze the received images, videos and/or sounds, and may generate 797 direction values and/or distance values or instructions for base assembly movement. In other words, image recognition or pattern recognition may be performed at any of the discussed assemblies or computing devices (e.g., base assembly 710, portable computing device 723, external computing device 729 and/or vending machine 700. In embodiments, computer-readable instructions executed by processors of an intelligent vending machine 700, a mobile computing device 723 and/or a computing device 729 may communicate 798 base assembly direction values and distance values to a base assembly 710 via a transceiver.

In embodiments, a base assembly processor/controller 715 may receive generated direction values and/or distance values and/or instructions, which generates messages, commands, and/or signals to cause 796 a drive assembly (e.g., a motor, shaft and/or wheels or a motor, shaft and/or treads) to move a base assembly 710 based at least in part on the generated direction values and/or distance values and/or instructions. In embodiments, one or more sensors 719, 721 and/or 722 in a base assembly 700 may generate sensor readings or measurements. In embodiments, a controller or processor and/or a transceiver 714 may communicate commands, instructions, signals and/or messages to a base motor controller 715 to identify movements and/or directions for a base assembly 700. In response, a vending machine controller send commands, instructions, and/or signals to a base assembly 710 identifying desired movements of a base assembly.

In embodiments, a base assembly 710 may comprise a processor/controller 711, a motor controller 715, a motor 716 and/or a drive assembly 717 which physical move a base assembly 710 (and thus the vending machine). As described above, many different components, systems and/or assemblies may communicate instructions, commands, messages and/or signals to a processor 711 and/or a base assembly motor controller 715. In embodiments, the instructions, commands, messages and/or signals may correspond to, be related to and/or indicative of direction values and/or distance values that a base assembly 710 may and/or should move. In embodiments, a base motor controller 715 may receive direction values and distance values or instructions and convert these pulses into signals, commands and/or messages for a motor and/or turbine 716. In embodiments, a motor and/or turbine 716 may be coupled, attached and/or connected to a driving assembly 717. In embodiments, a driving assembly 717 may drive a base assembly 710 to a location based at least in part on direction values and/or distance values. In embodiments, a driving assembly 717 may comprise one or more shafts, one or more axles and/one or more wheels 718. In embodiments, a motor 716 generates signals to cause shafts to rotate, axles to rotate, and/or wheels to spin and/or rotate which causes a base assembly 710 to move (and thus the intelligent vending machine). In embodiments, a driving assembly 717 may comprise one or more shafts, one or more conveying devices and one or more treads (e.g., tread assemblies). In embodiments, a motor 716 may generates signals, messages and/or commands to cause one or more shafts to rotate, which may cause one or more conveying devices to rotate, which in turns causes treads (and/or tread assemblies) to rotate and travel about a conveying device, where the one or more treads (and/or tread assemblies) cause a base assembly 710 to move. In embodiments, a motor and drive assembly may be replaced by an air exhaust system and air exhaust vents. In embodiments, a motor controller may be replaced by an exhaust system controller. In embodiments, an exhaust system controller may receive instructions, commands, messages and/or signals from a controller identifying movement distances and directional measurements for a base assembly 710. In embodiments, an exhaust system controller may convert the commands, messages and/or signals into signals and/or commands understandable by exhaust system components. In embodiments, an exhaust system (or exhaust system components) may control operation of air exhaust events on a base assembly 710 in order to move a base assembly a desired direction and/or distance. In embodiments, a base assembly 710 may hover and/or glide over a surface when being moved by operation of exhaust vents.

All references referred to in the present disclosure are incorporated by reference in their entirety. Although specific embodiments have been described above in detail, the description is merely for purposes of illustration. It should be appreciated, therefore, that many aspects described above are not intended as required or essential elements unless explicitly stated otherwise. Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, steps, blocks, operations, elements, and/or components, but do not preclude the presence or addition of one or more other features, blocks, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, assemblies, devices and/or sections, these elements, components, assemblies, devices and/or sections should not be limited by these terms. These terms may be only used to distinguish one element, component, assembly, device or section from another element, component, assembly, device or section. Terms such as “first,” “second,” and other numerical terms when used herein do not imply a sequence or order unless clearly indicated by the context. Thus, a first element, component, assembly, device or section discussed below could be termed a second element, component, device, assembly or section without departing from the teachings of the example embodiments.

A computing device may be a server, a computer, a laptop computer, a mobile computing device, a portable computing device, a mobile communications device, and/or a tablet. A computing device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, wearable haptic and touch communication device, a wearable haptic device, a non-wearable computing device having a touch-sensitive display, a remote computing device, a single board computer, and/or an integrated computing device combining various features, such as features of the forgoing devices, or the like.

As used herein, the term module, device, controller, or computing device may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module, device, controller, or computing device may also include memory (shared, dedicated, or grouped) that stores code executed by the one or more processors.

The term code, instructions, computer-executable instructions or computer-readable instructions, as used above, may include software, firmware, byte-code and/or microcode, and may refer to programs, routines, functions, classes, and/or objects. The term shared, as used above, means that some or all code, instructions, computer-executable instructions or computer-readable instructions from multiple modules, devices, computing devices, or controllers may be executed using a single (shared) processor. In addition, some or all code from multiple modules may be stored by a single (shared) memory. The term group, as used above, means that some or all code from a single module, computing device, device or controller may be executed using a group of processors. In addition, some or all code from a single module, computing device, device or controller may be stored using a group of memories.

The techniques described herein may be implemented by one or more computer programs (or computer-readable instructions) executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs, computer-readable instructions or computer-executable instructions. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “generating” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer or computing device selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers or computing devices referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers (or computing devices or servers) that are communicatively coupled to dissimilar computers (or computing devices or servers) and storage devices over a local area network, a wide area network and/or a global communications network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An automated vending machine, comprising:
one or more solar panels, the one or more solar panels converting solar energy or light energy into electrical energy;
a vending machine body, the one or more solar panels attached to a top surface of the vending machine body; and
one or more feet, the one or more feet to make contact with a surface, the one or more feet connected to the vending machine body and the one or more feet providing support to the vending machine,
wherein the vending machine body further comprises:
a product display area;
a product dispensing assembly to obtain a selected product from the product display area and deliver the selected product to an opening in a front surface of the vending machine body;
a liquid dispensing assembly to dispense liquid to a container positioned near the vending machine body;
a microphone to receive voice commands and to convert voice commands into audio signals; and
an audio transceiver and sound reproduction device, the audio transceiver to receive one or more audio files and to communicate the received one or more audio files to the sound reproduction device for playback.

2. The automated vending machine of claim 1, further comprising:
one or more propeller blades and wind turbines, the one or more propeller blades and wind turbines to capture wind in an environment surrounding an intelligent vending machine and convert the captured wind to additional electrical energy.

3. The automated vending machine of claim 1, further comprising one or more imaging devices, the one or more imaging devices to capture video, images and/or audio from an environment surrounding the automated vending machine.

4. The automated vending machine of claim 1, further comprising a user input device, the user input device comprising a display and a touch screen, the display presenting one or more product options and the touch screen receiving inputs from an operator to select one or the one or more product options presented on the display.

5. The automated vending machine of claim 1, further comprising an emergency generator beacon, the emergency generator beacon to transmit an emergency beacon into an environment surrounding the automated vending machine.

6. The automated vending machine of claim 1, further comprising one or more environmental sensors, the one or more environmental sensors capturing environmental measurements of an environment surrounding the vending machine, the one or more environmental sensors being a temperature sensor, a humidity sensor or an ultraviolet sensor.

7. The automated vending machine of claim 1, further comprising one or more directional sensors, the one or more directional sensors being one of a digital compass or a global positioning system transceiver, the one or more directional sensors capturing a position or location measurement for the automated vending machine.

8. The automated vending machine of claim 1, further comprising one or more proximity sensors, the one or more proximity sensors to detect motion in an area surrounding the automated vending machine, generate a detection signal or detection command and communicate the detection signal or detection command.

9. The automated vending machine of claim 1, further comprising one or more wireless communication transceivers, the one or more wireless communication transceivers to communicate with external computing devices to provide information regarding users or operators or status of components of the automated vending machine.

10. The automated vending machine of claim 1, further comprising an unmanned aerial vehicle (UAV), one or more processors, one or more memory devices, and computer-readable instructions, the computer-readable instructions executable by the one or more processors to cause the processor to communicate commands or instructions to the UAV.

11. The automated vending machine of claim 10, the UAV further comprising an imaging device to capture images from an aerial view of an area surrounding the automated vending machine,
wherein the computer-readable instructions executable by the one or more processors cause the one or more processors to communicate instructions or messages to the UAV to initiate flying operations and to activate the imaging device on the UAV to capture the aerial view images of the area surrounding the automated vending machine.

12. The automated vending machine of claim 10, further comprising a UAV interface port, the UAV interface port to attach to a surface of the vending machine body, and to attach to a UAV.

13. The automated vending machine of claim 1, further comprising a power converter, the power converter to receive power from solar cells and convert the power to electrical energy.

14. The automated vending machine of claim 13, further comprising a rechargeable battery, the rechargeable battery to receive electrical power from the power converter.

15. The automated vending machine of claim 14, further comprising an UAV interface port, the rechargeable battery to connect to the UAV interface port and to provide power to the UAV through the UAV interface port.

16. The automated vending machine of claim 1, further comprising a cooling assembly, the cooling assembly to cool a liquid that is to be dispensed from the liquid dispensing assembly.

17. The automated vending machine of claim 1, the vending machine body further comprising a computing device, the computing device comprising one or more processors, one or more memory devices, and computer-readable instructions accessed and executed by the one or more processors to control operations or activation of components of the automated vending machine.

18. The automated vending machine of claim 1, further comprising an input panel support and an input panel display, the input panel support connected to the vending machine body and the input panel assembly coupled to the panel support to receive tactile, audio and/or video input from an operator and to communicate with the automated vending machine.

19. The automated vending machine of claim 18, further comprising a panel imaging device, the panel imaging device to capture images, video or sound and communicate the captured images, video or sound to the vending machine.

20. The automated vending machine of claim 18, further comprising one or more panel microphones, the one or more panel microphones to capture audio commands from an operator and convert the audio commands to audio signals away from noise created by operation of the automated vending machine.
